(19) United States
(12) Patent Application Publication
(10) Pub. No.: US 2004/0202097 A1
(43) Pub. Date: Oct. 14, 2004

(54) Optical recording disk

(75) Inventors: Hisaji Oyake, Tokyo (JP); Yuuichi Kawaguchi, Tokyo (JP); Hiroaki Takahata, Tokyo (JP); Kouji Mishima, Tokyo (JP); Hiroyasu Inoue, Tokyo (JP); Tsuyoshi Komaki, Tokyo (JP); Masaki Aoshima, Tokyo (JP); Hironori Kakiuchi, Tokyo (JP)

Correspondence Address: SEED INTELLECTUAL PROPERTY LAW GROUP PLLC, 701 FIFTH AVE, SUITE 6300, SEATTLE, WA, 98104-7092, US

(73) Assignee: TDK Corporation, Tokyo (JP)

(21) Appl. No.: 10/818,324

(22) Filed: Apr. 5, 2004

(30) Foreign Application Priority Data
Apr. 8, 2003 (JP) 2003-103920

(51) Int. Cl. G11B 7/24

(52) U.S. Cl. 369/283; 369/288; 369/280; 369/44.13

(57) ABSTRACT

An optical recording disk includes a support substrate, grooves and lands alternately formed on one major surface of the support substrate, an optical functioning layer formed on the one major surface of the support substrate on which the grooves and the lands are formed and including a recording layer and a light transmission layer formed on the optical functioning layer, the grooves and the lands being formed so that the depth Gd of each of the grooves is equal to or larger than 15 nm and equal to or smaller than 25 nm and the half width Gw is equal to or larger than 150 nm and is equal to or smaller than 230 nm, and the recording layer including a first recording film containing Si as a primary component and a second recording film containing Cu as a primary component.

According to the thus constituted optical recording disk, it is possible to suppress jitter of a signal obtained by reading data within a predetermined range, thereby suppressing reading errors, and it is possible to maintain the level of a push-pull signal equal to or higher than a predetermined value, thereby enabling tracking control in a desired manner.

### BACKGROUND OF THE INVENTION

The present invention relates to an optical recording disk and, in particular, to an optical recording disk which can suppress jitter of a signal obtained by reading data within a predetermined range, thereby suppressing reading errors, and maintain the level of a push-pull signal equal to or higher than a predetermined value, thereby enabling tracking control in a desired manner.

### DESCRIPTION OF THE PRIOR ART

Optical recording disks such as the CD, DVD and the like have been widely used as recording media for recording a large amount of digital data.

These optical recording disks can be roughly classified into so-called ROM type optical recording disks such as the CD-ROM and the DVD-ROM that do not enable writing and rewriting of data, so-called write-once type optical recording disks such as the CD-R and DVD-R that enable writing but not rewriting of data, and data rewritable type optical recording disks such as the CD-RW and DVD-RW that enable rewriting of data.

As well known in the art, data are generally recorded in a ROM type optical recording disk using prepits formed in a substrate in the manufacturing process thereof, while in a data rewritable type optical recording disk a phase change material is generally used as the material of the recording layer and data are recorded utilizing changes in an optical characteristic caused by phase change of the phase change material.

On the other hand, in a write-once type optical recording disk, an organic dye such as a cyanine dye, phthalocyanine dye or azo dye is generally used as the material of the recording layer and data are recorded utilizing changes in an optical characteristic caused by chemical change of the organic dye, which change may be accompanied by physical deformation.

There has been recently proposed a next-generation type optical recording disk that is constituted so as to be irradiated with a blue laser beam for recording or reproducing data having a short wavelength of 400 nm to 430 nm from the opposite side through a support substrate made of polycarbonate or the like via an objective lens for recording or reproducing data having a large numerical aperture, and that has a light transmission layer on a recording layer, so that a larger amount of data can be recorded therein with high density and can be also reproduced therefrom.

For increasing storage capacity in the next-generation type optical recording disk, it is required to form tracks whose track pitch is equal to or smaller than half of that in the DVD, namely in the range of 0.25 μm to 0.34 μm.

However, in the case where the track pitch is made small in this manner, unless the grooves and lands are formed so as to have desired shapes, jitter of a signal obtained by reading data becomes higher, whereby reading errors are liable to occur and tracking cannot be controlled in a desired manner.

### SUMMARY OF THE INVENTION

It is therefore an object of the present invention is to provide an optical recording disk which can suppress jitter of a signal obtained by reading data within a predetermined range, thereby suppressing reading errors, and can maintain the level of a push-pull signal equal to or higher than a predetermined value, thereby enabling tracking control in a desired manner.

The inventors of the present invention vigorously pursued a study for accomplishing the above objects of the present invention and, as a result, made the discovery that in an optical recording disk comprising a support substrate, grooves and lands alternately formed on one major surface of the support substrate, an optical functioning layer formed on the one major surface of the support substrate on which the grooves and the lands are formed and including at least one recording layer and a light transmission layer formed on the optical functioning layer, if the grooves and the lands are formed so that the depth Gd of each of the grooves is equal to or larger than 15 nm and equal to or smaller than 25 nm and the half width Gw is equal to or larger than 150 nm and is equal to or smaller than 230 nm, it is possible to suppress jitter of a signal obtained by reading data within a predetermined range, thereby suppressing reading errors, and to maintain the level of a push-pull signal equal to or higher than a predetermined value, thereby enabling tracking control in a desired manner.

Therefore, the above and other objects of the present invention can be accomplished by an optical recording disk comprising a support substrate, grooves and lands alternately formed on one major surface of the support substrate, an optical functioning layer formed on the one major surface of the support substrate on which the grooves and the lands are formed and including at least one recording layer and a light transmission layer formed on the optical functioning layer, the grooves and the lands being formed so that the depth Gd of each of the grooves is equal to or larger than 15 nm and equal to or smaller than 25 nm and the half width Gw is equal to or larger than 150 nm and is equal to or smaller than 230 nm, and the at least one recording layer containing an inorganic element.

In the present invention, “major surface” means the surface whose area is largest.

In the present invention, the optical disk is preferably constituted so that data can be recorded therein and reproduced therefrom with a track pitch of 0.25 to 0.40 μm by projecting a light having a wavelength of 400 nm to 430 nm thereonto via an objective lens having a numerical aperture (NA) of 0.8 to 0.9 and the light transmission layer.

In a preferred aspect of the present invention, each of the grooves has a substantially trapezoidal cross section and each of the lands has a substantially trapezoidal cross section.

In a study done by the inventors of the present invention, it was found that jitter of reproduced data can be suppressed to a sufficiently low level by forming the grooves and the lands so that each of the grooves has a substantially trapezoidal cross section and each of the lands has a substantially trapezoidal cross section.

In the present invention, the statement that each of the grooves has a substantially trapezoidal cross section includes not only the case where each of the top surface and side surfaces thereof is formed by a substantially flat surface but also the case where each of the top surface and side surfaces thereof is formed by a curved surface and the statement that each of the lands has a substantially trapezoidal cross section includes not only the case where each of the top surface and side surfaces thereof is formed by a substantially flat surface but also the case where each of the top surface and side surfaces thereof is formed by a curved surface.

In a further preferred aspect of the present invention, the grooves and the lands are formed so that an angle θ the inclined surface between each groove and neighboring land makes with the support substrate is equal to or larger than 12 degrees and equal to or smaller than 30 degrees.

In a study done by the inventors of the present invention, it was found that jitter of reproduced data can be suppressed to a sufficiently low level by forming the grooves and the lands so that an angle θ that the inclined surface between each groove and neighboring land makes with the support substrate is equal to or larger than 12 degrees and equal to or smaller than 30 degrees.

In a further preferred aspect of the present invention, the grooves and the lands are formed so that the angle θ that the inclined surface between each groove and neighboring land makes with the support substrate is equal to or larger than 12 degrees and equal to or smaller than 25 degrees.

In a preferred aspect of the present invention, the grooves and the lands are formed in such a manner that each is wobbled so that the amplitude thereof with respect to an imaginary center line thereof is equal to or larger than ±7 nm.

In a study done by the inventors of the present invention, it was found that the C/N ratio of a wobble signal to noise can be improved by forming the grooves and the lands in such a manner that each is wobbled so that the amplitude thereof with respect to an imaginary center line thereof is equal to or larger than ±7 nm.

In a further preferred aspect of the present invention, the grooves and the lands are formed in such a manner that each is wobbled so that the amplitude thereof with respect to an imaginary center line thereof is equal to or smaller than ±25 nm.

In a study done by the inventors of the present invention, it was found that it is possible to improve the C/N ratio of a wobble signal to noise, while also suppressing residual tracking error to a low level, by forming the grooves and the lands in such a manner that each is wobbled so that the amplitude thereof with respect to an imaginary center line thereof is equal to or smaller than ±25 nm.

In a preferred aspect of the present invention, the at least one recording layer is constituted by a first recording film containing one element selected from the group consisting of Si, Ge, Sn, Mg, C, Al, Zn, In, Cu, Ti and Bi as a primary component and a second recording film provided in the vicinity of the first recording film and containing one element selected from the group consisting of Cu, Al, Zn, Ag, Ti and Si and different from the element contained in the first recording film as a primary component.

The inventors of the present invention vigorously pursued a study for improving the recording sensitivity of an optical recording disk and reducing the noise level of a signal reproduced from the optical recording disk. As a result, they made the discovery that in the case where a recording film is constituted by a first recording film containing one element selected from the group consisting of Si, Ge, Sn, Mg, C, Al, Zn, In, Cu, Ti and Bi as a primary component and a second recording film provided in the vicinity of the first recording film and containing one element selected from the group consisting of Cu, Al, Zn, Ag, Ti and Si and different from the element contained in the first recording film as a primary component, when data are recorded in the optical recording disk using a laser beam, a mixed region including the element contained in the first recording film as a primary component and the element contained in the second recording film as a primary component is formed, thereby forming a record mark and enabling the reflection coefficient of the region to be markedly changed. They further discovered that data can be recorded in the recording layer with high sensitivity and the noise level of a reproduced signal can be decreased to improve C/N ratio by utilizing the large difference in reflection coefficient between the region where a record mark is formed by mixing the primary component element of the first recording film and the primary component element of the second recording film, and blank regions where no record mark is formed.

In this specification, the statement that the first recording film contains a certain element as a primary component means that the content of the element is maximum among the elements contained in the first recording film, while the statement that the second recording film contains a certain element as a primary component means that the content of the element is maximum among the elements contained in the second recording film.

In the present invention, it is not absolutely necessary for the second recording film to be in contact with the first recording film and it is sufficient for the second recording film to be so located in the vicinity of the first recording film as to enable formation of a mixed region including the primary component element of the first recording film and the primary component element of the second recording film when the region is irradiated with a laser beam. Further, one or more other layers such as a dielectric layer may be interposed between the first recording film and the second recording film.

Although the reason why a mixed region including the primary component element of the first recording film and the primary component element of the second recording film can be formed to form a record mark when irradiated with a laser beam is not altogether clear, it is reasonable to conclude that the primary component elements of the first and second recording films are partially or totally fused or diffused, thereby forming a region where the primary component elements of the first and second recording films mix.

The reflection coefficient that the region where a record mark is thus formed by mixing the primary component elements of the first and second recording films exhibits with respect to a laser beam for reproducing data and the reflection coefficient that blank regions exhibit with respect to the laser beam for reproducing data are considerably different and, therefore, recorded data can be reproduced with high sensitivity by utilizing such large difference in the reflection coefficients.

In another preferred aspect of the present invention, the optical functioning layer comprises a plurality of recording layers and at least one recording layer other than a recording layer farthest from the light transmission layer is constituted by a first recording film containing one element selected from the group consisting of Si, Ge, Sn, Mg, C, Al, Zn, In, Cu, Ti and Bi as a primary component and a second recording film provided in the vicinity of the first recording film and containing one element selected from the group consisting of Cu, Al, Zn, Ag, Ti and Si and different from the element contained in the first recording film as a primary component.

In the case where the optical functioning layer of an optical recording disk includes a plurality of recording layers, since a laser beam passes through a recording layer other than a recording layer farthest from a light transmission layer when data are recorded in or reproduced from the recording layer farthest from the light transmission layer, if the difference in light transmittances between a region of the recording layer other than the recording layer farthest from the light transmission layer where a record mark is formed and a blank region thereof where no record mark is formed is great, when data are recorded in the recording layer farthest from the light transmission layer, the amount of the laser beam projected onto the recording layer farthest from the light transmission layer greatly changes depending upon whether the region of the recording layer other than the recording layer farthest from the light transmission layer through which the laser beam passes is a region where a record mark is formed or a blank region and when data are reproduced from the recording layer farthest from the light transmission layer, the amount of the laser beam reflected from the recording layer farthest from the light transmission layer, transmitting through the recording layer other than the recording layer farthest from the light transmission layer and detected greatly change depending upon whether the region of the recording layer other than the recording layer farthest from the light transmission layer through which the laser beam passes is a region where a record mark is formed or a blank region. As a result, the recording characteristics of the recording layer farthest from the light transmission layer and the amplitude of a signal reproduced from the recording layer farthest from the light transmission layer change greatly depending upon whether the region of the recording layer other than the recording layer farthest from the light transmission layer through which the laser beam passes is a region where a record mark is formed or a blank region.

In particular, when data recorded in the recording layer farthest from the light transmission layer are reproduced, if the region of the recording layer other than the recording layer farthest from the light transmission layer through which the laser beam passes contains a boundary between a region where a record mark is formed and a blank region, since the distribution of the reflection coefficient is not uniform at the spot of the laser beam, data recorded in the recording layer farthest from the light transmission layer cannot be reproduced in a desired manner.

The inventors of the present invention vigorously pursued a study for solving these problems and made the discovery that the difference in light transmittances for a laser beam having a wavelength of 400 nm to 430 nm between the region of a record mark formed by mixing the element contained in the first recording film as a primary component and selected from the group consisting of Si, Ge, Sn, Mg, C, Al, Zn, In, Cu, Ti and Bi and the element contained in the second recording film as a primary component and selected from the group consisting of Cu, Al, Zn, Ag, Ti and Si and different from the element contained in the first recording film as a primary component and a blank region of the first recording film and the second recording film is equal to or lower than 4% and the difference in light transmittances between the region of a record mark and the blank region is sufficiently small.

Therefore, according to this preferred aspect of the present invention, when data are recorded in the recording layer other than the recording layer farthest from the light transmission layer, the element contained in the first recording film as a primary component and the element contained in the second recording film as a primary component are mixed with each other by a laser beam, thereby forming a record mark whose reflection coefficient is different from blank regions and data can be recorded in the at least one recording layer with high sensitivity. Further, since the difference in light transmittances for a laser beam having a wavelength of 400 nm to 430 nm between a region where a record mark is formed and a blank region is equal to or lower than 4% and sufficiently small, in the case of recording data in the farthest recording layer from the light transmission layer or reproducing data from the farthest recording layer from the light transmission layer by irradiating it with a laser beam having a wavelength of 400 nm to 430 nm via the at least one recording layer, even if a region of the recording layer through which the laser beam is transmitted contains a boundary between a region where a record mark is formed and a blank region, it is possible to record data in the farthest recording layer from the light transmission layer and reproduce data from the farthest recording layer from the light transmission layer in a desired manner.

In the present invention, it is preferable to form the second recording film so as to be in contact with the first recording film.

In the present invention, the optical functioning layer may include one or more recording films containing one element selected from the group consisting of Si, Ge, Sn, Mg, C, Al, Zn, In, Cu, Ti and Bi as a primary component or one or more recording films containing one element selected from the group consisting of Cu, Al, Zn, Ag, Ti and Si and different from the element contained in the first recording film as a primary component in addition to the first recording film and the second recording film.

In a preferred aspect of the present invention, the second recording film is further added with at least one element selected from the group consisting of Cu, Al, Zn, Ag, Mg, Sn, Au, Ti and Pd and different from the element contained in the second recording film as a primary component.

According to this preferred aspect of the present invention, it is possible to improve the storage reliability and the recording sensitivity of the optical recording disk.

In a further preferred aspect of the present invention, the second recording film is further added with at least one element selected from a group consisting of Al, Zn, Sn and Au and different from the element contained in the second recording film as a primary component.

According to this preferred aspect of the present invention, it is possible to markedly improve the stability of the second recording film against oxidation or sulfurization and to effectively prevent degradation of the appearance of the optical recording disk, such as by peeling of the second recording film and the like owing to corrosion of the element contained in the second recording film as a primary component, and change in the reflection coefficient of the optical recording disk during long storage.

In a preferred aspect of the present invention, the first recording film is further added with one or more elements selected from a group consisting of Mg, Al, Cu, Ag and Au and different from the element contained in the first recording film.

According to this preferred aspect of the present invention, it is possible to further improve the recording sensitivity of the optical recording disk.

In the present invention, the first recording film more preferably contains one element selected from a group consisting of Si, Ge, Sn, Mg and Al as a primary component and particularly preferably contains one element selected from a group consisting of Si, Ge and Sn as a primary component.

In the case where the first recording film contains one element selected from a group consisting of Si, Ge, Sn, Mg and Al as a primary component, it is possible to further improve a C/N ratio of a reproduced signal.

In the present invention, the second recording film preferably contains Cu as a primary component.

The initial recording characteristic can be particularly improved in comparison with conventional optical recording disks when the second recording film containing Cu as a primary component is formed by a vacuum deposition process or a sputtering process because the surface smoothness thereof becomes very good. Since the recording layers of the optical recording disk according to the present invention therefore have excellent surface smoothness, it is possible to markedly improve the recording characteristic when data are recorded by a laser beam having a reduced spot diameter. Moreover, since Cu is quite inexpensive, the cost of the materials used to fabricate the optical recording disk can be minimized.

In another preferred aspect of the present invention, the optical functioning layer comprises a plurality of recording layers laminated via at least intermediate layers, at least one of the recording layers other than a recording layer farthest from a light transmission layer among the plurality of recording layers containing at least one metal M selected from a group consisting of Ni, Cu, Si, Ti, Ge, Zr, Nb, Mo, In, Sn, W, Pb, Bi, Zn and La and an element X which can combine with the metal M upon being irradiated with a laser beam for recording data, thereby forming a crystal of a compound of the element X with the metal M.

In a study done by the inventors of the present invention, it was found that in the case where at least one of the recording layers other than the recording layer farthest from the light transmission layer among the plurality of recording layers contains at least one metal M selected from a group consisting of Ni, Cu, Si, Ti, Ge, Zr, Nb, Mo, In, Sn, W, Pb, Bi, Zn and La and an element X which can combine with the metal M upon being irradiated with a laser beam for recording data, thereby forming a crystal of a compound of the element X with the metal M, the recording layer has a sufficiently high transmittance with respect to the laser beam.

Therefore, according to this preferred aspect of the present invention, since it is possible to suppress the reduction in the power of the laser beam to the minimum during the period required for arrival of the laser beam at the farthest recording layer from the light transmission layer, it is possible to record data in the farthest recording layer from the light transmission layer in a desired manner. On other hand, when data are to be reproduced from the farthest recording layer from the light transmission layer, since it is possible to suppress the reduction in the power of the laser beam to the minimum during the period required for arrival of the laser beam reflected by the farthest recording layer from the light incidence plane, it is possible to reproduce data recorded in the farthest recording layer from the light transmission layer in a desired manner.

Further, according to this preferred aspect of the present invention, since data are recorded in the recording layer containing the metal M and the element X by projecting the laser beam for recording data and combining the metal M and the element X to form a crystal of a compound of the metal M with the element X, it is possible to increase the difference in reflection coefficients with respect to a laser beam between a region where the compound of the metal M with the element X is crystallized and other regions and it is therefore possible to record in and reproduce from not only the farthest recording layer from the light transmission layer but also the recording layer(s) other than the farthest recording layer from the light transmission layer in a desired manner.

In a further preferred aspect of the present invention, all of the recording layers other than the farthest recording layer from the light transmission layer among the plurality of recording layers contain at least one metal M selected from a group consisting of Ni, Cu, Si, Ti, Ge, Zr, Nb, Mo, In, Sn, W, Pb, Bi, Zn and La and an element X which can combine with the metal M upon being irradiated with a laser beam for recording data, thereby forming a crystal of a compound of the element X with the metal M, and are formed in such a manner that the recording layers closer to the light transmission layer are thinner.

According to this preferred aspect of the present invention, since it is possible to much more improve the light transmittance of the recording layers other than the farthest recording layer from the light transmission layer as a whole, it is possible to record data in and reproduce data from the farthest recording layer from the light transmission layer in a desired manner.

Further, in a study done by the inventors of the present invention, it was found that in the case where all of the recording layers other than the farthest recording layer among the plurality of recording layers contain at least one metal M selected from a group consisting of Ni, Cu, Si, Ti, Ge, Zr, Nb, Mo, In, Sn, W, Pb, Bi, Zn and La and an element X which can combine with the metal M upon being irradiated with a laser beam for recording data, thereby forming a crystal of a compound of the element X with the metal M, and are formed in such a manner that the recording layers closer to the light transmission layer are thinner, the reflection coefficients of the recording layers farther from the light transmission layer with respect to the laser beam become higher and it is therefore possible to reproduce data from the recording layers other than the farthest recording layer from the light transmission layer in a desired manner.

In a further preferred aspect of the present invention, the optical functioning layer includes a first recording layer, a second recording layer and a third recording layer from the side of the support substrate in this order and the first recording layer, the second recording layer and the third recording layer are formed so that the second recording layer has a thickness of 15 nm to 50 nm and that a ratio of the thickness of the third recording layer to the thickness of the second recording layer is 0.40 to 0.70.

In a study done by the inventors of the present invention, it was found that in the case where the optical functioning layer includes a first recording layer, a second recording layer and a third recording layer from the side of the substrate in this order and the first recording layer, the second recording layer and the third recording layer are formed so that the second recording layer has a thickness of 15 nm to 50 nm and that the ratio of the thickness of the third recording layer to the thickness of the second recording layer is 0.40 to 0.70, the amount of the laser beam absorbed by the second recording layer and that absorbed by the third recording layer can be made substantially equal to each other and they can be set to sufficiently high levels, namely, 10% to 30%. Therefore, according to this preferred aspect of the present invention, it is possible to record data in the second recording layer and the third recording layer in a desired manner by projecting laser beams having substantially the same power thereonto.

Further, a study carried out by the inventors of the present invention revealed that in the case where the optical functioning layer includes a first recording layer, a second recording layer and a third recording layer from the side of the substrate in this order and the first recording layer, the second recording layer and the third recording layer are formed so that the second recording layer has a thickness of 15 nm to 50 nm and that the ratio of the thickness of the third recording layer to the thickness of the second recording layer is 0.40 to 0.70, the reflection coefficient of the second recording layer and that of the third recording layer with respect to the laser beam can be made substantially equal to each other and they can be made substantially high. Therefore, according to this preferred aspect of the present invention, it is possible to reproduce data from the second recording layer and the third recording layer in a desired manner.

In the present invention, it is more preferable to form the third recording layer and the second recording layer so that a ratio of the thickness of the third recording layer to that of the second recording layer is 0.46 to 0.69 and it is most preferable to form the second recording layer and the third recording layer so that a ratio of the thickness of the third recording layer to that of the second recording layer is 0.50 to 0.63.

In a further preferred aspect of the present invention, the optical functioning layer includes a first recording layer, a second recording layer, a third recording layer and a fourth recording layer from the side of the substrate in this order and the first recording layer, the second recording layer, the third recording layer and the fourth recording layer are formed so that the second recording layer has a thickness of 20 nm to 50 nm, that a ratio of the thickness of the third recording layer to the thickness of the second recording layer is 0.48 to 0.93 and that a ratio of the thickness of the fourth recording layer to that of the second recording layer is 0.39 to 0.70.

In a study done by the inventors of the present invention, it was found that in the case where the optical functioning layer includes a first recording layer, a second recording layer, a third recording layer and a fourth recording layer from the side of the substrate in this order and the first recording layer, the second recording layer, the third recording layer and the fourth recording layer are formed so that the second recording layer has a thickness of 20 nm to 50 nm, that the ratio of the thickness of the third recording layer to the thickness of the second recording layer is 0.48 to 0.93 and that the ratio of the thickness of the fourth recording layer to that of the second recording layer is 0.39 to 0.70, the amount of the laser beam absorbed by the second recording layer, that absorbed by the third recording layer and that absorbed by the fourth recording layer can be made substantially equal to each other and they can be set to sufficiently high levels, namely, 10% to 20%. Therefore, according to this preferred aspect of the present invention, it is possible to record data in the second recording layer, the third recording layer and the fourth recording layer in a desired manner by projecting laser beams having substantially the same power thereonto.

Further, in a study done by the inventors of the present invention, it was found that in the case where the optical functioning layer includes a first recording layer, a second recording layer, a third recording layer and a fourth recording layer from the side of the substrate in this order and the first recording layer, the second recording layer, the third recording layer and the fourth recording layer are formed so that the second recording layer has a thickness of 20 nm to 50 nm, that the ratio of the thickness of the third recording layer to the thickness of the second recording layer is 0.48 to 0.93 and that the ratio of the thickness of the fourth recording layer to that of the second recording layer is 0.39 to 0.70, the reflection coefficient of the second recording layer, that of the third recording layer and that of the fourth recording layer with respect to the laser beam can be made substantially equal to each other and they can be made substantially high. Therefore, according to this preferred aspect of the present invention, it is possible to reproduce data from the second recording layer, the third recording layer and the fourth recording layer in a desired manner.

In the present invention, it is more preferable to form the second recording layer, the third recording layer and the fourth recording layer so that a ratio of the thickness of the third recording layer to that of the second recording layer is 0.50 to 0.90 and a ratio of the thickness of the fourth recording layer to that of the second recording layer is 0.39 to 0.65 and it is most preferable to form the second recording layer, the third recording layer and the fourth recording layer so that a ratio of the thickness of the third recording layer to that of the second recording layer is 0.57 to 0.80 and a ratio of the thickness of the fourth recording layer to that of the second recording layer is 0.42 to 0.54.

In a further preferred aspect of the present invention, the element X is constituted of at least one element selected from a group consisting of S, O, C and N.

S, O, C and N are highly reactive to at least one of metal M selected from the group consisting of Ni, Cu, Si, T, Ge, Zr, Nb, Mo, In, Sn, W, Pb, Bi, Zn and La and can be preferably used as the element X. In particular, O and S included in the sixth group elements are adequately reactive to the metal M and, unlike F or Cl included in the seventh group elements, do not react with the metal M without being irradiated with a laser beam for recording data, so that O and S are particularly preferable for the element X.

In a further preferred aspect of the present invention, the at least one recording layer containing the metal M and the element X further contains at least one metal selected from a group consisting of Mg, Al and Ti.

In the present invention, in the case where the at least one recording layer containing the metal M and the element X further contains Mg, it is preferable for the at least one recording layer to contain 18.5 atomic % to 33.7 atomic % of Mg and it is more preferable for the at least one recording layer to contain 20.0 atomic % to 33.5 atomic % of Mg.

On the other hand, in the present invention, in the case where the at least one recording layer containing the metal M and the element X further contains Al, it is preferable for the at least one recording layer to contain 11 atomic % to 40 atomic % of Al and it is more preferable for the at least one recording layer to contain 18 atomic % to 32 atomic % of Al.

Moreover, in the present invention, in the case where the at least one recording layer containing the metal M and the element X further contains Ti, it is preferable for the at least one recording layer to contain 8 atomic % to 34 atomic % of Ti and it is more preferable for the at least one recording layer to contain 10 atomic % to 26 atomic % of Ti.

In a further preferred aspect of the present invention, the farthest recording layer among the plurality of recording layers includes a first recording film containing Cu as a primary component and a second recording film containing Si as a primary component.

According to this preferred aspect of the present invention, since the farthest recording layer among the plurality of recording layers includes a first recording film containing Cu as a primary component and a second recording film containing Si as a primary component, it is possible to suppress the noise level of a signal obtained by reproducing data recorded in the farthest recording layer from the light transmission layer to a lower level and it is possible to increase the change in reflection coefficient between before and after the recording of data. Further, even when the optical recording disk has been stored for a long time, recorded data can be prevented from being degraded and the reliability of the optical recording disk can be increased.

In another preferred aspect of the present invention, the optical functioning layer comprises a plurality of recording layers laminated via at least intermediate layers, at least one of the recording layers other than a recording layer farthest from a light transmission layer among the plurality of recording layers containing at least one kind of metal selected from a group consisting of Ni, Cu, Si, Ti, Ge, Zr, Nb, Mo, In, Sn, W, Pb, Bi, Zn and La and at least one element selected from a group consisting of S,O, C and N as a primary component and being added with at least one kind of metal selected from a group consisting of Mg, Al and Ti.

According to the study of the inventors of the present invention, it was found that in the case where the at least one of the recording layers other than a recording layer farthest from the light transmission layer among the plurality of recording layers contains at least one metal selected from a group consisting of Ni, Cu, Si, Ti, Ge, Zr, Nb, Mo, In, Sn, W, Pb, Bi, Zn and La and at least one element selected from a group consisting of S,O, C and N as a primary component and is added with at least one metal selected from a group consisting of Mg, Al and Ti, the recording layer has a sufficiently high transmittance with respect to the laser beam.

Therefore, according to this preferred aspect of the present invention, it is possible to record data in and reproduce data from the farthest recording layer from the light transmission layer in a desired manner and it is also possible to record data in and reproduce data from the recording layer(s) other than the farthest recording layer from the light transmission layer.

In the present invention, it is preferable for all of the recording layers other than the farthest recording layer from the light transmission layer among the plurality of recording layers to contain at least one metal selected from a group consisting of Ni, Cu, Si, Ti, Ge, Zr, Nb, Mo, In, Sn, W, Pb, Bi, Zn and La and at least one element selected from a group consisting of S,O, C and N as a primary component and to be added with at least one metal selected from a group consisting of Mg, Al and Ti.

In a preferred aspect of the present invention, the recording layer containing at least one metal selected from a group consisting of Ni, Cu, Si, Ti, Ge, Zr, Nb, Mo, In, Sn, W, Pb, Bi, Zn and La and at least one element selected from a group consisting of S,O, C and N as a primary component and being added with at least one metal selected from a group consisting of Mg, Al and Ti is formed by a vapor growth process using a target containing at least one metal selected from a group consisting of Ni, Cu, Si, Ti, Ge, Zr, Nb, Mo, In, Sn, W, Pb, Bi, Zn and La and at least one element selected from a group consisting of S,O, C and N as a primary component and a target containing at least one metal selected from a group consisting of Mg, Al and Ti as a primary component.

In a further preferred aspect of the present invention, the recording layer containing at least one metal selected from a group consisting of Ni, Cu, Si, Ti, Ge, Zr, Nb, Mo, In, Sn, W, Pb, Bi, Zn and La and at least one element selected from a group consisting of S,O, C and N as a primary component and being added with at least one metal selected from a group consisting of Mg, Al and Ti is formed by a vapor growth process using a target containing a mixture of ZnS and SiO₂ or a mixture of La₂O₃, SiO₂ and Si₃N₄ as a primary component and a target containing at least one metal selected from a group consisting of Mg, Al and Ti as a primary component.

In a further preferred aspect of the present invention, the recording layer containing at least one metal selected from a group consisting of Ni, Cu, Si, Ti, Ge, Zr, Nb, Mo, In, Sn, W, Pb, Bi, Zn and La and at least one element selected from a group consisting of S,O, C and, N as a primary component and being added with at least one metal selected from a group consisting of Mg, Al and Ti is formed by a vapor growth process using a target consisting of a mixture of ZnS and SiO₂ or a mixture of La₂O₃, SiO₂ and Si₃N₄ and a target consisting of at least one metal selected from a group consisting of Mg, Al and Ti.

In the present invention, in the case where the target containing the mixture of ZnS and SiO₂ is used, it is preferable to set a mole ratio of ZnS to SiO₂ to be 50:50 to 90:10 and more preferably set to be about 80:20.

In the case where the mole ratio of ZnS in the mixture of ZnS and SiO₂ is equal to or larger than 50%, the reflection coefficient and the light transmittance of the recording layer with respect to a laser beam can be simultaneously improved and in the case where the mole ratio of ZnS in the mixture of ZnS and SiO₂ is equal to or smaller than 90%, it is possible to effectively prevent cracks from being generated in the recording layer owing to stress. Further, in the case where the mole ratio of ZnS to SiO₂ of the mixture of ZnS and SiO₂ is about 80:20, both of the reflection coefficient and the light transmittance of the recording layer with respect to a laser beam can be much more improved, while it is possible to more effectively prevent cracks from being generated in the recording layer.

Further, in the present invention, in the case where the target containing the mixture of La₂O₃, SiO₂ and Si₃N₄ is used, it is preferable to set a mole ratio of SiO₂ to La₂O₃ and Si₃N₄ to be 10:90 to 50:50 and it is more preferable to set a mole ratio of La₂O₃, SiO₂ and Si₃N₄ to be 20:30:50.

In the case where the mole ratio of SiO₂ in the mixture of La₂O₃, SiO₂ and Si₃N₄ is equal to or smaller than 10%, cracks tend to be generated in the recording layer and in the case where the mole ratio of SiO₂ in the mixture of La₂O₃, SiO₂ and Si₃N₄ exceeds 50%, the refractive index of the recording layer becomes low, whereby the reflection coefficient of the recording layer becomes low. On the other hand, in the case where the mole ratio of La₂O₃ and Si₃N₄ is 50% to 90%, it is possible to increase the refractive index of the recording layer and to prevent cracks from being generated in the recording layer.

The above and other objects and features of the present invention will become apparent from the following description made with reference to the accompanying drawings.

### BRIEF DESCRIPTION OF THE DRAWINGS

FIG. 1 is a schematic enlarged cross-sectional view showing an optical recording disk that is a preferred embodiment of the present invention.

FIG. 2 is a schematic cross-sectional view showing details of a cross section of a groove G and a land L.

FIG. 3 is a schematic cross-sectional view showing an optical recording disk that is another preferred embodiment of the present invention.

FIG. 4 is a schematic cross-sectional view showing an optical recording disk that is a further preferred embodiment of the present invention.

FIG. 5 is an enlarged schematic cross-sectional view showing a first recording layer of an optical recording disk shown in FIG. 4.

FIG. 6 is a schematic cross-sectional view showing an optical recording disk that is a further preferred embodiment of the present invention.

FIG. 7 is a graph showing how jitter of a reproduced signal varied with the depth of a groove in Working Example 1.

FIG. 8 is a graph showing how a push-pull signal varied with the depth of a groove in Working Example 1.

FIG. 9 is a graph showing how jitter of a reproduced signal varied with the half width Gw of a groove in Working Example 2.

FIG. 10 is a graph showing how a push-pull signal varied with the half width Gw of a groove in Working Example 2.

FIG. 11 is a graph showing how a ratio of a wobble carrier to noise (wobble C/N ratio) varied with the amplitude Wob of wobbling of a groove in Working Example 3.

FIG. 12 is a graph showing how residual tracking error component (residual noise component) varied with the amplitude Wob of wobbling of a groove in Working Example 3.

### DESCRIPTION OF THE PREFERRED EMBODIMENTS

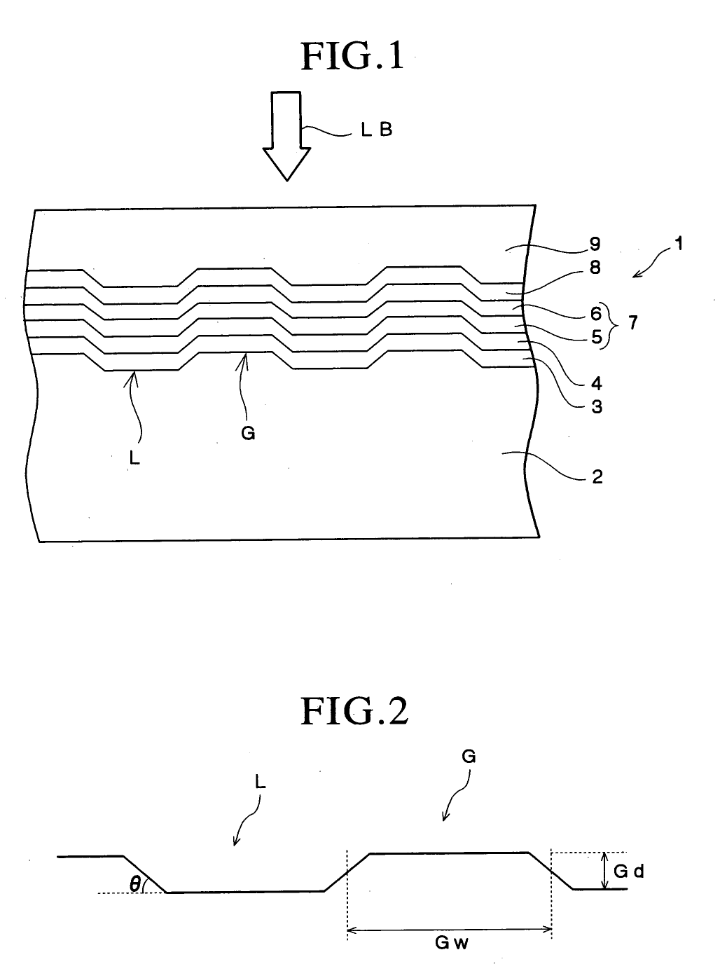

FIG. 1 is a schematic enlarged cross-sectional view showing an optical recording disk that is a preferred embodiment of the present invention.

As shown in FIG. 1, an optical recording disk 1 according to this embodiment is constituted as a write-once type optical recording disk and includes a support substrate 2, a reflective layer 3, a second dielectric layer 4, a second recording film 5, a first recording film 6, a first dielectric layer 8 and a light transmission layer 9. In this embodiment, a recording layer is constituted by the first recording film 6 and the second recording film 5.

The support substrate 2 serves as a support for ensuring mechanical strength required for the optical recording disk 1.

The material used to form the support substrate 2 is not particularly limited insofar as the substrate can serve as the support of the optical recording disk 1. The support substrate 2 can be formed of glass, ceramic, resin or the like. Among these, resin is preferably used for forming the support substrate 2 since resin can be easily shaped. Illustrative examples of resins suitable for forming the support substrate 2 include polycarbonate resin, acrylic resin, epoxy resin, polystyrene resin, polyethylene resin, polypropylene resin, silicone resin, fluoropolymers, acrylonitrile butadiene styrene resin, urethane resin and the like. Among these, polycarbonate resin is most preferably used for forming the support substrate 2 from the viewpoint of easy processing, optical characteristics and the like. In this embodiment, the support substrate 2 is formed of polycarbonate resin.

In this embodiment, the support substrate 2 has a thickness of about 1.1 mm.

As shown in FIG. 1, grooves G each having a substantially trapezoidal cross section and lands L each having a substantially trapezoidal cross section are alternately formed on one major surface of the support substrate 2.

As well known, the support substrate 2 is formed by an injection molding process using a stamper (not shown) formed on one major surface thereof with a symmetrical raised and depressed pattern to that of the grooves G and the lands L to be formed on the one major surface of the support substrate 2.

FIG. 2 is a schematic cross-sectional view showing details of a cross section of a groove G and land L.

As shown in FIG. 2, in this embodiment, the grooves G and the lands L are formed so that each has a substantially trapezoidal cross section, the depth Gd of the groove is equal to or larger than 15 nm and equal to or smaller than 25 nm and the half width Gw of the groove G is equal to or larger than 150 nm and equal to smaller than 230 nm.

As shown in FIG. 2, the grooves G and the lands L are formed so that the angle θ that the inclined surface between each groove G and neighboring land L makes with the one major surface of the support substrate 2 is equal to or larger than 12 degrees and equal to or smaller than 30 degrees.

The support substrate 2 is formed of polycarbonate, for example, and as shown in FIG. 1, a reflective layer 3 is formed using a sputtering process or the like on the one major surface of the support substrate 2 on which the grooves G and the lands L are formed.

The reflective layer 3 serves to reflect the laser beam LB entering through the light transmission layer 9 so as to emit it from the light transmission layer 9.

The thickness of the reflective layer 3 is not particularly limited but is preferably from 10 nm to 300 nm, more preferably from 20 nm to 200 nm.

The material used to form the reflective layer 3 is not particularly limited insofar as it can reflect a laser beam LB, and the reflective layer 3 can be formed of Mg, Al, Ti, Cr, Fe, Co, Ni, Cu, Zn, Ge, Ag, Pt, Au and the like. Among these materials, it is preferable to form the reflective layer 3 of a metal material having a high reflection characteristic, such as Al, Au, Ag, Cu or alloy containing at least one of these metals, such as alloy of Al and Ti.

The reflective layer 3 is provided in order to increase the difference in reflection coefficient between a recorded region and an unrecorded region by a multiple interference effect when the laser beam LB is used to reproduce data from the recording layer 7, thereby obtaining a higher reproduced signal (C/N ratio).

As shown in FIG. 1, a second dielectric layer 4 is formed using a sputtering process or the like on the surface of the reflective layer 3 and a second recording film 5 is formed using a sputtering process or the like on the surface of the second dielectric layer 4.

As shown in FIG. 1, a first recording film 6 is formed using a sputtering process or the like on the surface of the second recording film 5 and a recording layer 7 is constituted the first recording film 6 and the second recording film 5.

As shown in FIG. 1, a first dielectric layer 8 is formed using a sputtering process or the like on the surface of the first recording film 6 and a light transmission layer 9 is formed on the first dielectric layer 8.

The first dielectric layer 8 and the second dielectric layer 4 serve to protect the recording layer 7. Degradation of recorded data can be prevented over a long period by the first dielectric layer 8 and the second dielectric layer 4. Further, since the second dielectric layer 4 also serves to prevent the support substrate 2 and the like from being deformed by heat, it is possible to effectively prevent jitter and the like from becoming worse due to the deformation of the support substrate 2 and the like.

The dielectric material used to form the first dielectric layer 8 and the second dielectric layer 4 is not particularly limited insofar as it is transparent and the first dielectric layer 8 and the second dielectric layer 4 can be formed of a dielectric material containing oxide, sulfide, nitride or a combination thereof, for example, as a primary component. More specifically, in order to prevent the support substrate 2 and the like from being deformed by heat and thus protect the recording layer 7, it is preferable for the first dielectric layer 8 and the second dielectric layer 4 to contain at least one kind of dielectric material selected from the group consisting of Al₂O₃, AlN, ZnO, ZnS, GeN, GeCrN, CeO, SiO, SiO₂, SiN and SiC as a primary component and it is more preferable for the first dielectric layer 8 and the second dielectric layer 4 to contain ZnS.SiO₂ as a primary component.

The thickness of the first dielectric layer 8 and the second dielectric layer 4 is not particularly limited but is preferably from 3 nm to 200 nm. If the first dielectric layer 8 or the second dielectric layer 4 is thinner than 3 nm, it is difficult to obtain the above-described advantages. On the other hand, if the first dielectric layer 8 or the second dielectric layer 4 is thicker than 200 nm, it takes a long time to form the first dielectric layers 8 and the second dielectric layers 4, thereby lowering the productivity of the optical recording disk 1, and cracks may be generated in the optical recording disk 1 owing to stress present in the first dielectric layers 8 and/or the second dielectric layer 4.

In this embodiment, the light transmission layer 9 is formed by applying an ultraviolet ray curable resin solution onto the surface of the first dielectric layer using a spin coating process to form a coating layer and projecting ultraviolet rays onto the coating layer, thereby curing the ultraviolet ray curable resin. As a result, as shown in FIG. 1, the pattern of the grooves G and the lands L formed on the one major surface of the support substrate 2 is transferred onto the major surface of the light transmission layer 9 facing the support substrate 2, whereby the same raised and depressed pattern of grooves G and lands L as that of the grooves G and the lands L formed on the one major surface of the support substrate 2 is formed thereon.

The optical recording disk according this embodiment is constituted so that data are recorded in the recording layer 7 by projecting a laser beam LB having a wavelength of 400 nm to 430 nm via an objective lens (not shown) having a numerical aperture (NA) of 0.8 to 0.9 and the light-transmission layer 9 in a direction indicated by an arrow in FIG. 1 and data are reproduced from the recording layer 7 by projecting the laser beam LB thereonto via the light transmission layer 9.

In this embodiment, the first recording film 6 contains Si as a primary component and the second recording film 5 contains Cu as a primary component.

When a laser beam LB is projected onto the first recording film 6 and the second recording film 5 via the light transmission layer 9, Cu contained in the second recording film 5 as a primary component quickly mixes Si contained in the first recording film 6 as a primary component to form a region where a record mark is formed. Since the mixed region of the recording layer 7 where a record mark is formed by mixing Si and Cu has a greatly different reflection coefficient from that of blank regions of the recording layer 7 where no record mark is formed, data can be quickly recorded in the recording layer 7.

In order to further improve the recording sensitivity of the optical recording disk 1, it is preferable to add one or more elements selected from a group consisting of Mg, Al, Cu, Ag and Au to the first recording film 6.

It is preferable to further add at least one element selected from a group consisting of Al, Zn, Sn and Au to the second recording film 5.

In the case where the second recording film 5 is further added with at least one element selected from a group consisting of Al, Zn, Sn and Au, it is possible to markedly improve the stability of the second recording film 5 against oxidation or sulfurization and to effectively prevent degradation of the appearance of the optical recording disk 1, such as by peeling of the second recording film 5 and the like owing to corrosion of Cu contained in the second recording film 5 as a primary component, and change in the reflection coefficient of the optical recording disk 1 during long storage.

In order to improve the recording sensitivity of the optical recording disk 1, it is particularly preferable to add Au to the second recording film 5.

The thickness of the recording layer 7, namely, the total thickness of the first recording film 6 and the second recording film 5 is not particularly limited insofar as Si contained in the first recording film 6 as a primary component and Cu contained in the second recording film 5 as a primary component at a region irradiated with a laser beam LB are quickly fused or diffused to quickly form a region where Si contained in the first recording film 6 as a primary component and Cu contained in the second recording film 5 as a primary component are mixed and a record mark, but the total thickness of the first recording film 6 and the second recording film 5 is preferably equal to or more than 2 nm and equal to or less than 100 nm and more preferably equal to or more than 2 nm and equal to or less than 50 nm.

When the total thickness of the first recording film 6 and the second recording film 5 exceeds 100 nm, the mixing rate of the primary component elements of the first and second recording layers 11 and 12 is low and it becomes difficult to record information at high speed.

On the other hand, in the case where the total thickness of the first recording film 6 and the second recording film 5 is less than 2 nm, the change in reflection coefficient between before and after irradiation with the laser beam LB is small so that a reproduced signal having high strength cannot be obtained.

The individual thicknesses of the first recording film 6 and the second recording film 5 are not particularly limited but in order to considerably improve the recording sensitivity and greatly increase the change in reflection coefficient between before and after irradiation with the laser beam LB, the thickness of the first recording film 6 is preferably from 1 nm to 30 nm and the thickness of the second recording film 5 is preferably from 1 nm to 30 nm.

Further, it is preferable to define the ratio of the thickness of the first recording film 6 to the thickness of the second recording film 5 (thickness of first recording film 6/thickness of second recording film 5) to be from 0.2 to 5.0.

Although not shown in FIGS. 1 and 2, in this embodiment, the grooves G and the lands L are formed in such a manner that each is wobbled so that the amplitude Wob thereof with respect to an imaginary center line thereof is equal to or larger than ±7 nm and equal to or smaller than ±25 nm.

In a study done by the inventors of the present invention, it was found that in the optical recording disk 1 in which the grooves G and the lands L are formed on the one major surface of the support substrate 2 and the major surface of the light transmission layer 9 facing the support substrate 11 in the above described manner, it is possible to suppress jitter of a signal obtained by reading data within a predetermined range, thereby suppressing reading errors, and maintain the level of a push-pull signal equal to or higher than a predetermined value, thereby enabling tracking control in a desired manner.

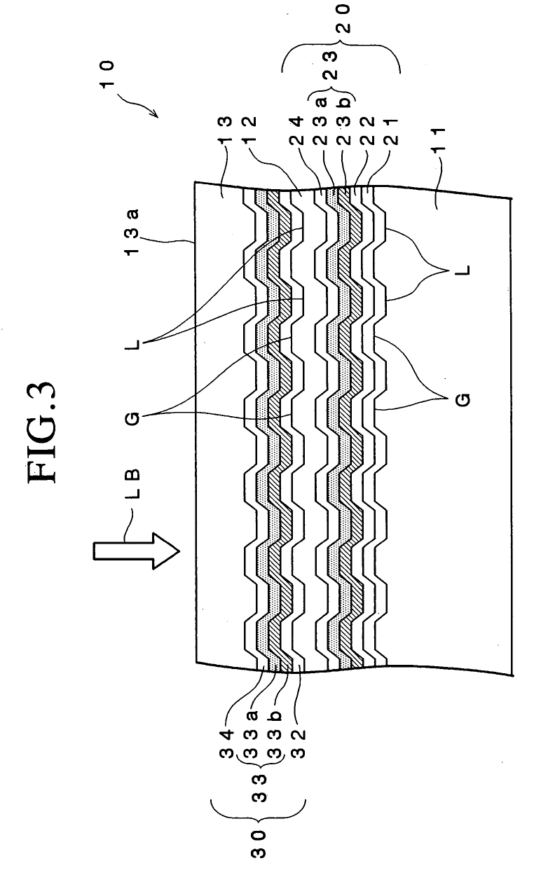

FIG. 3 is a schematic cross-sectional view showing an optical recording disk that is another preferred embodiment of the present invention.

As shown in FIG. 3, an optical recording disk 10 according to this embodiment is constituted as a write-once type optical recording disk and includes a support substrate 11, a transparent intermediate layer 12, a light transmission layer 13, an L0 layer 20 formed between the support substrate 11 and the light transmission layer 13, and an L1 layer 30 formed between the transparent layer 12 and the transparent intermediate layer 12.

The L0 layer 20 and the L1 layer 30 are recording layers in which data are recorded, i.e., the optical recording disk 10 according to this embodiment includes two recording layers.

The L0 layer 20 constitutes a recording layer far from a light incident plane 13a and is constituted by laminating a reflective film 21, a fourth dielectric film 22, an L0 recording layer 23 and a third dielectric film 24 from the side of the support substrate 11.

On the other hand, the L1 layer 30 constitutes a recording layer close to the light incident plane 13a and is constituted by laminating a reflective film 31, a second dielectric film 32, an L1 recording layer 33 and a first dielectric film 34.

In the case where data are to be recorded in the L0 layer 20 and data recorded in the L0 layer 20 are to be reproduced, a laser beam LB L is projected thereon through the L1 layer 30 located closer to the light transmission layer 13.

Therefore, it is necessary for the L1 layer 30 to have a high light transmittance. Concretely, the L1 layer 30 has a light transmittance equal to or higher than 30% with respect to the laser beam LB used for recording data and reproducing data and preferably has a light transmittance equal to or higher than 40%.

Similarly to in the optical recording disk 1, the support substrate 11 is formed of polycarbonate resin, for example.

As shown in FIG. 3, grooves G each having a substantially trapezoidal cross section and lands L each having a substantially trapezoidal cross section are alternately formed on one major surface of the support substrate 11 and, similarly to in the optical recording disk 1 shown in FIGS. 1 and 2, in this embodiment, the grooves G and the lands L are formed so that the depth Gd of the groove is equal to or larger than 15 nm and equal to or smaller than 25 nm, the half width Gw of the groove G is equal to or larger than 150 nm and equal to smaller than 230 nm and the angle θ that the inclined surface between each groove G and neighboring land L makes with the one major surface of the support substrate 11 is equal to or larger than 12 degrees and equal to or smaller than 30 degrees.

Although not shown in FIG. 3, in this embodiment, the grooves G and the lands L are formed in such a manner that each is wobbled so that the amplitude Wob thereof with respect to an imaginary center line thereof is equal to or larger than ±7 nm and equal to or smaller than ±25 nm.

The transparent intermediate layer 12 serves to space the L0 layer 20 and the L1 layer 30 apart by a physically and optically sufficient distance.

As shown in FIG. 3, a similar raised and depressed pattern of grooves G and lands L to that of the grooves G and the lands L formed on the one major surface of the support substrate 11 is formed on the major surface of the transparent intermediate layer 12 facing the light transmission layer 13.

The transparent intermediate layer 12 is formed by applying an ultraviolet ray curable resin solution onto the surface of the L0 layer 20 using a spin coating method to form a coating film and projecting ultraviolet rays onto the surface of the coating film via a stamper (not shown) whose surface is formed with a similar raised and depressed pattern to that of a stamper (not shown) used for fabricating the support substrate 11. As a result, the similar raised and depressed pattern of grooves G and lands L to that of the grooves G and the lands L formed on the one major surface of the support substrate 11 is formed on the major surface of the transparent intermediate layer 12 facing the light transmission layer 13.

It is preferable to form the transparent intermediate layer 12 so as to have a thickness of 5 μm to 50 μm and it is more preferable to form it so as to have a thickness of 10 μm to 40 μm.

It is necessary for the transparent intermediate layer 12 to have sufficiently high light transmittance since the laser beam LB passes through the transparent intermediate layer 12 when data are to be recorded in the L0 layer 20 and data recorded in the L0 layer 20 are to be reproduced.

The light transmission layer 13 serves to transmit the laser beam LB and the light incident plane 13a is constituted by one of the surfaces thereof.

As shown in FIG. 3, grooves G and lands L having a similar raised and depressed pattern to that of the grooves G and the lands L formed on the major surface of the transparent intermediate layer 12 on the side of the L1 layer 30, namely, that of the grooves G and the lands L formed on the major surface of the support substrate 11 on the side of the L0 layer 20, is formed on the major surface of the light transmission layer 13 facing the transparent intermediate layer 12.

The light transmission layer 13 is formed by applying an ultraviolet ray curable resin solution onto the surface of the L1 layer 30 using a spin coating method to form a coating film and projecting ultraviolet rays onto the surface of the coating film, thereby curing the coating film. As a result, the raised and depressed pattern of the grooves G and the lands L formed on the major surface of the transparent intermediate layer 12 on the side of the L1 layer 30, namely, the raised and depressed pattern of the grooves G and the lands L formed on the major surface of the support substrate 11 on the side of the L0 layer 20, is transferred onto the major surface of the light transmission layer 13 facing the transparent intermediate layer 12, thereby forming grooves G and lands L having a similar raised and depressed pattern to that formed on the one major surface of the support substrate 11 on the side of the L0 layer 20 on the major surface of the light transmission layer 13 facing the transparent intermediate layer 12.

It is preferable to form the light transmission layer 13 so as to have a thickness of 30 μm to 200 μm.

As shown in FIG. 3, the L0 recording layer 23 included in the L0 layer 20 includes a first L0 recording film 23a and a second L0 recording film 23b in contact with the first L0 recording film 23a.

The first L0 recording film 23a and the second L0 recording film 23b are formed similarly to the first recording film 6 and the second recording film 5 constituting the recording layer 7 of the optical recording disk 1 shown in FIGS. 1 and 2 so that the first L0 recording film 23a contains Si as a primary component and that the second L0 recording film 23b contains Cu as a primary component.

Therefore, when a laser beam LB is projected onto the L0 recording layer 23, Si contained in the first L0 recording film 23a as a primary component and Cu contained in the second L0 recording film 23b as a primary component quickly mixes each other to form a mixed region, thereby forming a record mark in the L0 recording layer 23 and recording data therein.

Similarly, as shown in FIG. 3, the L1 recording layer 33 included in the L1 layer 30 includes a first L1 recording film 33a and a second L1 recording film 33b in contact with the first L1 recording film 33a.

The first L1 recording film 33a and the second L1 recording film 33b are formed similarly to the first recording film 6 and the second recording film 5 constituting the recording layer 7 of the optical recording disk 1 shown in FIGS. 1 and 2 so that the first L1 recording film 33a contains Si as a primary component and that the second L1 recording film 33b contains Cu as a primary component.

Therefore, when a laser beam LB is projected onto the L1 recording layer 33, Si contained in the first L1 recording film 33a as a primary component and Cu contained in the second L1 recording film 33b as a primary component quickly mixes each other to form a mixed region, thereby forming a record mark in the L1 recording layer 33 and recording data therein.

Since the laser beam LB passes through the L1 recording layer 33 when data are recorded in the L0 recording layer 23 included in the L0 layer 20 and when data are reproduced from the L0 recording layer 23 included in the L0 layer 20, if the difference in light transmittances between a region of the L1 recording layer 33 where a record mark is formed and a blank region of the L1 recording layer 33 where no record mark is formed is great, when data are recorded in the L0 recording layer 23 included in the L0 layer 20, the amount of the laser beam LB projected onto the L0 recording layer 23 greatly changes depending upon whether the region of the L1 recording layer 33 through which the laser beam LB passes is a region where a record mark is formed or a blank region and when data are reproduced from the L0 recording layer 23 included in the L0 layer 20, the amount of the laser beam LB reflected from the L0 recording layer 23, transmitting through the L1 layer 30 and detected greatly change depending upon whether the region of the L1 recording layer 33 through which the laser beam LB passes is a region where a record mark is formed or a blank region. As a result, the recording characteristics of the L0 recording layer 23 and the amplitude of a signal reproduced from the L0 recording layer 23 change greatly depending upon whether the region of the L1 recording layer 33 through which the laser beam LB passes is a region where a record mark is formed or a blank region.

In particular, when data recorded in the L0 recording layer 23 are reproduced, if the region of the L1 recording layer 33 through which the laser beam LB passes contains a boundary between a region where a record mark is formed and a blank region, since the distribution of the reflection coefficient is not uniform at the spot of the laser beam LB, data recorded in the L0 recording layer 23 cannot be reproduced in a desired manner.

In a study done by the inventors of the present invention, it was found that in order to record data in the L0 recording layer 23 and reproduce data from the L0 recording layer 23, it is necessary for the difference in light transmittances between a region of the L1 recording layer 33 where a record mark is formed and a blank region of the L1 recording layer 33 to be equal to or lower than 4%.

The inventors of the present invention further found that the difference in light transmittances for a laser beam LB having a wavelength of 400 nm to 430 nm between the region of a record mark formed by mixing Si and Cu and a blank region of the L1 recording layer 33 formed by laminating the first L1 recording film 33a containing Si as a primary component and the second L1 recording film 33b containing Cu as primary component is equal to or lower than 4% and the difference in light transmittances for a laser beam LB having a wavelength of about 405 nm between a region of the L1 recording layer 33 where a record mark is formed and a blank region of the L1 recording layer 33 is equal to or lower than 1%.

In this embodiment, the first L1 recording film 33a of the, L1 recording layer 33 contains Si as primary component and the second L1 recording film 33b of the L1 recording layer 33 contains Cu as primary component so that when the laser beam LB is projected thereonto via the light incident plane 13a, Si contained in the first L1 recording film 33a as a primary component and Cu contained in the second L1 recording film 33b as a primary component are mixed with each other, thereby forming a record mark. It is therefore possible to record data in the L0 recording layer 23 and reproduce data from the L0 recording layer 23 in a desired manner by projecting a laser beam LB onto the L0 recording layer 23 via the L1 layer 30.

Since the laser beam LB passes through the L1 recording layer 33 when data are to be recorded in the L0 recording layer 23 included in the L0 layer 20 and data recorded in the L0 recording layer 23 of the L0 layer 20 are to be reproduced, it is necessary for the L1 recording layer 33 to have a high light transmittance and it is therefore preferable to form the L1 recording layer 33 so as to be thinner than the L0 recording layer 23.

Concretely, it is preferable to form the L0 recording layer 23 so as to have a thickness of 2 nm to 40 nm and form the L1 recording layer 33 so as to have a thickness of 2 nm to 15 nm.

In the case where the thickness of the L1 recording layer 33 and the L0 recording layer 23 is thinner than 2 nm, the change in reflection coefficient between before and after irradiation with the laser beam LB is small so that a reproduced signal having high strength (C/N ratio) cannot be obtained.

On the other hand, when the thickness of the L1 recording layer 33 exceeds 15 nm, the light transmittance of the L1 layer 30 is lowered and the recording characteristic and the reproducing characteristic of the L0 recording layer 23 are degraded.

Further, when the thickness of the L0 recording layer 23 exceeds 40 nm; the recording sensitivity of the L0 recording layer 23 is degraded.

Furthermore, in order to increase the change in reflection coefficient between before and after irradiation with the laser beam LB, it is preferable to define the ratio of the thickness of the first L1 recording film 33a included in the L1 recording layer 33 to the thickness of the second L1 recording film 33b (thickness of the first L1 recording film 33a/thickness of the second L1 recording film 33b) and the ratio of the thickness of the first L0 recording film 23a included in the L0 recording layer 23 to the thickness of the second L0 recording film 23b (thickness of the first L0 recording film 23a/thickness of the second L0 recording film 23b) to be from 0.2 to 5.0.

The third dielectric film 24 and the fourth dielectric film 22 serve as protective layers for protecting the L0 recording layer 23 and the first dielectric film 34 and the second dielectric film 32 serve as protective layers for protecting the L1 recording layer 33.

The thickness of each of the first dielectric film 34, the second dielectric film 32, the third dielectric film 24 and the fourth dielectric film 22 is not particularly limited and it preferably has a thickness of 10 nm to 200 nm. In the case where the thickness of each of the first dielectric film 34, the second dielectric film 32, the third dielectric film 24 and the fourth dielectric film 22 is thinner than 10 nm, each of the first dielectric film 34, the second dielectric film 32, the third dielectric film 24 and the fourth dielectric film 22 does not sufficiently serve as a protective layer. On the other hand, in the case where the thickness of each of the first dielectric film 34, the second dielectric film 32, the third dielectric film 24 and the fourth dielectric film 22 exceeds 200 nm, a long time is required for forming it, thereby lowering the productivity of the optical recording disk 10 and there is some risk of cracking the L0 recording layer 23 and the L1 recording layer 33 due to internal stress.

The material for forming the first dielectric film 34, the second dielectric film 32, the third dielectric film 24 and the fourth dielectric film 22 is not particularly limited but it is preferable to form the first dielectric film 34, the second dielectric film 32, the third dielectric film 24 and the fourth dielectric film 22 of oxide, sulfide, nitride of Al, Si, Ce, Zn, Ta, Ti and the like such as A1₂O₃, AlN, SiO₂, Si₃N₄, CeO₂, ZnS, TaO and the like or a combination thereof and it is more preferable for them to contain ZnS.SiO₂ as a primary component. ZnS.SiO₂ means a mixture of ZnS and SiO₂.

The reflective film 31 included in the L1 layer 30 serves to reflect the laser beam LB entering the light incident plane 13a so as to emit it from the light incident plane 13a and effectively radiate heat generated in the L1 recording layer 33 by the irradiation with the laser beam LB.

When data are to be recorded in the L0 recording layer 23 of the L0 layer 20 and data recorded in the L0 recording layer 23 of the L0 layer 20 are to be reproduced, the laser beam LB entering the light incident plane 13a impinges onto the L0 recording layer 23 of the L0 layer 20 via the reflective film 31 included in the L1 layer 30. It is therefore necessary to form the reflective film 31 of a material having a high light transmittance and a high thermal conductivity. Further, it is necessary to form the reflective film 31 of a material having long-term storage reliability.

Therefore, in this embodiment, the reflective film 31 included in the L1 layer 30 contains Ag as a primary component and is added with 0.5 atomic % to 0.5 atomic % of C.

Since the light transmittance and thermal conductivity of the reflective film 31 included in the L1 layer 30 varies depending upon the amount of C added to the reflective film 31, the thickness of the reflective film 31 is determined based on the amount of C added to the reflective film 31 but, normally, the thickness of the reflective film 31 is preferably thinner than 20 nm and more preferably 5 nm to 15 nm.

The reflective film 21 included in the L0 layer 20 serves to reflect the laser beam LB entering through the light incident plane 13a so as to emit it from the light incident plane 13a and effectively radiate heat generated in the L0 recording film 23 by the irradiation with the laser beam LB.

The reflective film 21 included in the L0 layer 20 is preferably formed so as to have a thickness of 20 nm to 200 nm. When the reflective film 21 included in the L0 layer 20 is thinner than 20 nm, it does not readily radiate heat generated in the L0 recording layer 23. On the other hand, when the reflective film 21 is thicker than 200 nm, the productivity of the optical recording disk 10 is lowered since a long time is required for forming the reflective film 21 and there is a risk of cracking the reflective film 21 due to internal stress or the like.

The material for forming the reflective film 21 included in the L0 layer 20 is not particularly limited. The reflective film 21 may be formed of the same material as that used for forming the reflective film 31 but unlike the case of forming the reflective film 31 included in the L1 layer 30, it is unnecessary to consider the light transmittance of the material when a material is selected for forming the reflective film 21 included in the L0 layer 20.

In a study done by the inventors of the present invention, it was found that that in the optical recording disk 1 in which the grooves G and the lands L are formed on the one major surface of the support substrate 11 and the major surface of the transparent intermediate layer 12 facing the light transmission layer 13 facing the support substrate 11 in the above described manner, it is possible to suppress jitter of a signal obtained by reading data within a predetermined range, thereby suppressing reading errors, and maintain the level of a push-pull signal equal to or higher than a predetermined value, thereby enabling tracking control in a desired manner.

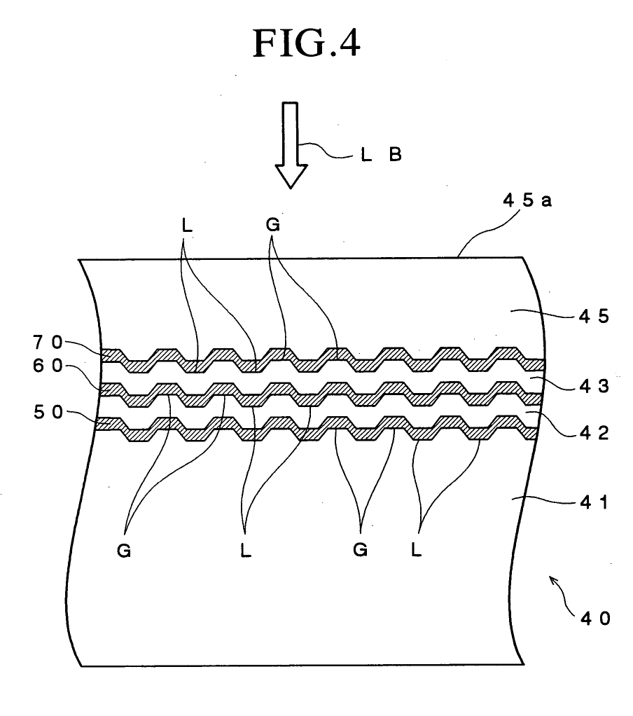

FIG. 4 is a schematic cross-sectional view showing an optical recording disk that is a further preferred embodiment of the present invention.

As shown in FIG. 4, the optical recording disk 40 according to this embodiment is constituted as a write-once type optical recording disk and includes a support substrate 41, a first recording layer 50, a first transparent intermediate layer 42, a second recording layer 60, a second transparent intermediate layer 43, a third recording layer 70 and a light transmission layer 45.

The first recording layer 50, the second recording layer 60 and the third recording layer 70 are recording layers in which data are recorded, i.e., the optical recording disk 40 according to this embodiment includes three recording layers.

As shown in FIG. 4, the optical recording disk 40 according to this embodiment is constituted so that a laser beam LB is projected onto the light transmission layer 45 and a light incidence plane 45a is constituted by one surface of the light transmission layer 45.

As shown in FIG. 4, the first recording layer 50 constitutes a recording layer farthest from the light incident plane 45a and the third recording layer 70 constitutes a recording layer closest too from the light incident plane 45a.

When data are to be recorded in the first recording layer 50, the second recording layer 60 or the third recording layer 70 or when data recorded in the first recording layer 50, the second recording layer 60 or the third recording layer 70 are to be reproduced, a blue laser beam LB having a wavelength λ of 400 nm to 430 nm is projected from the side of the light incidence plane 45a and focused onto one of the first recording layer 50, the second recording layer 60 and the third recording layer 70.

Therefore, when data are to be recorded in the first recording layer 50 or when data recorded in the first recording layer 50 are to be reproduced, the first recording layer 50 is irradiated with the laser beam LB via the second recording layer 60 and the third recording layer 70 and when data are to be recorded in the second recording layer 60 or when data recorded in the second recording layer 60 are to be reproduced, the second recording layer 60 is irradiated with the laser beam LB via the third recording layer 70.

Similarly to in the optical recording disk 1, the support substrate 41 is formed of polycarbonate resin, for example.

As shown in FIG. 4, grooves G each having a substantially trapezoidal cross section and lands L each having a substantially trapezoidal cross section are alternately formed on one major surface of the support substrate 41 and similarly to in the optical recording disk 1 shown in FIGS. 1 and 2, in this embodiment, the grooves G and the lands L are formed so that the depth Gd of the groove is equal to or larger than 15 nm and equal to or smaller than 25 nm, the half width Gw of the groove G is equal to or larger than 150 nm and equal to smaller than 230 nm and the angle θ the inclined surface between each groove G and neighboring land L makes with the one major surface of the support substrate 31 is equal to or larger than 12 degrees and equal to or smaller than 30 degrees.

Although not shown in FIG. 4, in this embodiment, the grooves G and the lands L are formed in such a manner that each is wobbled so that the amplitude Wob thereof with respect to an imaginary center line thereof is equal to or larger than ±7 nm and equal to or smaller than ±25 nm.

As shown in FIG. 4, the first recording layer 50 is formed on the surface of the support substrate 41.

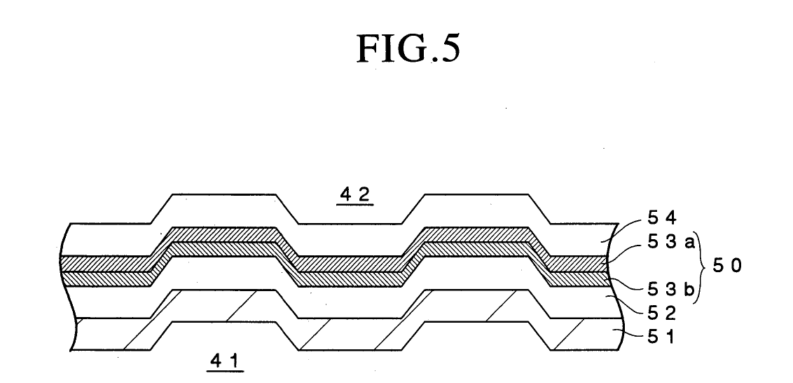

FIG. 5 is an enlarged schematic cross-sectional view showing the first recording layer 50.

As shown in FIG. 5, the first recording layer 50 is constituted by laminating a reflective film 51, a second dielectric film 52, a second recording film 53b, a first recording film 53a and a first dielectric film 54.

As shown in FIG. 5, the reflective film 51 is formed using a vapor growth process such as a sputtering process on the surface of the support substrate 41.

The reflective film 51 serves to reflect the laser beam LB entering the light incident plane 45a so as to emit it from the light incident plane 45a and effectively radiate heat generated in the second recording film 53b and the first recording film 53a by the irradiation with the laser beam LB.

The material used to form the reflective film 51 is not particularly limited insofar as it can reflect a laser beam LB, and the reflective film 51 can be formed of Mg, Al, Ti, Cr, Fe, Co, Ni, Cu, Zn, Ge, Ag, Pt, Au and the like. Among these materials, it is preferable to form the reflective film 51 of Al, Au, Ag, Cu or alloy thereof since they have a high reflection coefficient and high thermal conductivity.

The reflective film 51 is preferably formed so as to have a thickness of 20 nm to 200 nm. When the reflective film 51 is thinner than 20 nm, it is difficult to form the reflective film 51 having a sufficiently high reflection coefficient and the reflective film 51 does not readily radiate heat generated in the first recording layer 50. On the other hand, when the reflective film 51 is thicker than 200 nm, the productivity of the optical recording disk 40 is lowered since a long time is required for forming the reflective film 51 and there is a risk of cracking the reflective film 51 due to internal stress or the like.

As shown in FIG. 5, the second dielectric film 52 is formed using a vapor growth process such as a sputtering process on the surface of the reflective film 51.

The second dielectric film 52 serves to prevent the support substrate 41 from being deformed by heat and also serves as a protective film for protecting the first recording film 53a and the second recording film 53b together with the first dielectric film 54.

The dielectric material for forming the second dielectric film 52 is not particularly limited insofar as it is transparent in the wavelength range of the laser beam LB and the second dielectric film 52 can be formed of a dielectric material containing oxide, nitride, sulfide, fluoride or a combination thereof, for example, as a primary component. The second dielectric film 52 is preferably formed of oxide, nitride, sulfide, fluoride or a combination thereof containing at least one metal selected from the group consisting of Si, Ge, Zn, Al, Ta, Ti, Co, Zr, Pb, Ag, Sn, Ca, Ce, V, Cu, Fe and Mg. The mixture of ZnS and SiO₂ is particularly preferable as a dielectric material for forming the second dielectric film 52 and the mole ratio of ZnS to SiO₂ is preferably 50:50 to 85:15 and more preferably about 80:20.

As shown in FIG. 5, the second recording film 53b is formed using a vapor growth process such as a sputtering process on the surface of the second dielectric film 52 and the first recording film 53a is further formed using a vapor growth process such as a sputtering process on the surface of the second recording film 53b.

The first recording film 53a and the second recording film 53b are recording films in which data are to be recorded.

In this embodiment, the second recording film 53b contains Cu as a primary component and the first recording film 53a contains Si as a primary component.

It is preferable for the second recording film 53b containing Cu as a primary component to be added with at least one element selected from the group consisting of Al, Zn, Sn, Mg and Au. In the case where the at least one element selected from the group consisting of Al, Zn, Sn, Mg and Au is added to the second recording film 53b containing Cu as a primary component, it is possible to decrease the noise level in the reproduced signal and improve the long term storage reliability.

It is preferable to form the first recording film 53a and the second recording film 53b so that the total thickness thereof is 2 nm to 40 nm.

In the case where the total thickness of the first recording film 53a and the second recording film 53b is thinner than 2 nm, the change in reflection coefficient between before and after irradiation with the laser beam LB is small so that a reproduced signal having a high C/N ratio cannot be obtained. On the other hand, when the total thickness of the first recording film 53a and the second recording film 53b exceeds 40 nm, the recording characteristic of the first recording layer 50 is degraded.

The individual thicknesses of the first recording film 53a and the second recording film 53b are not particularly limited but it is preferable to define the ratio of the thickness of the first recording film 53a to the thickness of the second recording film 53b, namely, thickness of first recording film 53a/thickness of second recording film 53b to be from 0.2 to 5.0.

As shown in FIG. 5, the first dielectric film 54 is formed using a vapor growth process such as a sputtering process on the surface of the first recording film 53a.

The first dielectric film 54 can be formed of the material usable for forming the second dielectric film 52.

As shown in FIG. 4, the first transparent intermediate layer 42 is formed on the surface of the first recording layer 50.

The first transparent intermediate layer 42 serves to space the first recording layer 50 and the second recording layer 60 apart by a physically and optically sufficient distance.

As shown in FIG. 4, a similar raised and depressed pattern of grooves G and lands L to that of the grooves G and the lands L formed on the one major surface of the support substrate 41 is formed on the major surface of the first transparent intermediate layer 42 facing the light transmission layer 45.

The first transparent intermediate layer 42 is formed by applying an ultraviolet ray curable resin solution onto the surface of the first recording layer 50 using a spin coating method to form a coating film and projecting ultraviolet rays onto the surface of the coating film via a stamper (not shown) whose surface is formed with a similar raised and depressed pattern to that of a stamper (not shown) used for fabricating the support substrate 41. As a result, the similar raised and depressed pattern of grooves G and lands L to that of the grooves G and the lands L formed on the one major surface of the support substrate 41 is formed on the major surface of the first transparent intermediate layer 42 facing the light transmission layer 45.

As shown in FIG. 4, the second recording layer 60 is formed using a vapor growth process such as a sputtering process on the first transparent intermediate layer 42 and the second transparent intermediate layer 43 is formed on the surface of the second recording layer 60.

The second transparent intermediate layer 43 serves to space the second recording layer 60 and the third recording layer 70 apart by a physically and optically sufficient distance.

As shown in FIG. 4, a similar raised and depressed pattern of grooves G and lands L to that of the grooves G and the lands L formed on the one major surface of the support substrate 41 is formed on the major surface of the second transparent intermediate layer 43 facing the support substrate 41.

The second transparent intermediate layer 43 is formed by applying an ultraviolet ray curable resin solution onto the surface of the second recording layer 60 using a spin coating method to form a coating film and projecting ultraviolet rays onto the surface of the coating film via a stamper (not shown) whose surface is formed with a similar raised and depressed pattern to that of a stamper (not shown) used for fabricating the support substrate 41. As a result, the similar raised and depressed pattern of grooves G and lands L to that of the grooves G and the lands L formed on the one major surface of the support substrate 41 is formed on the major surface of the second transparent intermediate layer 43 facing the second recording layer 60.

It is necessary for the first transparent intermediate layer 42 to have sufficiently high light transmittance since the laser beam LB passes through the first transparent intermediate layer 42 when data are to be recorded in the first recording layer 50 and data recorded in the first recording layer 50 are to be reproduced and it is necessary for the second transparent intermediate layer 43 to have sufficiently high light transmittance since the laser beam LB passes through the second transparent intermediate layer 43 when data are to be recorded in the first recording layer 50 and data recorded in the first recording layer 50 are to be reproduced and when data are to be recorded in the second recording layer 60 and data recorded in the second recording layer 60 are to be reproduced.

It is preferable to form each of the first transparent intermediate layer 42 and the second transparent intermediate layer 43 so as to have a thickness of 5 μm to 50 μm and it is more preferable to form it so as to have a thickness of 10 μm to 40 μm.

The second recording layer 60 is a recording layer in which data are to be recorded and in this embodiment, the second recording layer 60 is constituted as a single film.

As shown in FIG. 4, the third recording layer 70 is formed using a vapor growth process such as a sputtering process on the surface of the second transparent intermediate layer 43.

The third recording layer 70 is a recording layer in which data are to be recorded and in this embodiment, the third recording layer 70 is constituted as a single film.

In this embodiment, each of the second recording layer 60 and the third recording layer 70 contains Zn, Si, S and O as a primary component and at least one metal selected from the group consisting of Mg, Al and Ti as an additive.

Concretely, the second recording layer 60 is formed on the surface of the first intermediate layer 12 by a vapor growth process such as a sputtering process using a target consisting of the mixture of ZnS and SiO₂ and a target consisting of at least one metal selected from the group consisting of Mg, Al and Ti. During the process for forming the second recording layer 60, the at least one metal selected from the group consisting of Mg, Al and Ti acts on the mixture of ZnS and SiO₂ as a reducing agent and as a result, Zn is separated from S and simple substances of Zn are uniformly dispersed in the second recording layer 60.

On the other hand, although not altogether clear, it is reasonable to conclude that the at least one metal selected from the group consisting of Mg, Al and Ti combines a part of S separated from Zn or S contained in ZnS to form a compound.

The mole ratio of ZnS to SiO₂ of the mixture of ZnS and SiO₂ contained in the target used for forming the second recording layer 60 is preferably set to be 50:50 to 90:10 and more preferably set to be about 80:20.

In the case where the mole ratio of ZnS in the mixture of ZnS and SiO₂ is set equal to or larger than 50%, the reflection coefficient and the light transmittance of the second recording layer 60 with respect to a laser beam LB can be simultaneously improved and in the case where the mole ratio of ZnS in the mixture of ZnS and SiO₂ is set equal to or smaller than 90%, it is possible to effectively prevent cracks from being generated in the second recording layer 60 owing to stress.

Further, in the case where the mole ratio of ZnS to SiO₂ of the mixture of ZnS and SiO₂ is set to be about 80:20, both of the reflection coefficient and the light transmittance of the second recording layer 60 with respect to a laser beam LB can be much more improved, while it is possible to more effectively prevent cracks from being generated in the second recording layer 60.

In this embodiment, in the case where Mg is contained in the second recording layer 60, the content of Mg is preferably 18.5 atomic % to 33.7 atomic % and more preferably 20 atomic % to 33.5 atomic %.

On the other hand, in the case where Al is contained in the second recording layer 60, the content of Al is preferably 11 atomic % to 40 atomic % and more preferably 18 atomic % to 32 atomic %.

Further, in the case where Ti is contained in the second recording layer 60, the content of Ti is preferably 8 atomic % to 34 atomic % and more preferably 10 atomic % to 26 atomic %.

In this embodiment, the third recording layer 30 has the same composition as that of the second recording layer 60 and, therefore, the third recording layer 70 is formed on the surface of the second transparent intermediate layer 43 by a vapor growth process such as a sputtering process using a target consisting of the mixture of ZnS and SiO₂ and a target consisting of at least one metal selected from the group consisting of Mg, Al and Ti.

Further, in this embodiment, the second recording layer 60 is formed so as to have a thickness of 15 nm to 50 nm and the third recording layer 70 is formed so that the ratio D3/D2 of the thickness D3 of the third recording layer 70 to the thickness D2 of the second recording layer 60 is 0.40 to 0.70.

Since a laser beam LB passes through the second recording layer 60 when data are to be recorded in or data recorded in the first recording layer 50 are to be reproduced, it is necessary for the second recording layer 60 to have sufficiently high light transmittance so that a signal having a high level can be obtained when data recorded in the first recording layer 30 are reproduced. Further, since a laser beam LB passes through the third recording layer 70 when data are to be recorded in the first recording layer 50 or data recorded in the first recording layer 50 are to be reproduced or when data are to be recorded in the second recording layer 60 or data recorded in the second recording layer 60 are to be reproduced, it is necessary for the third recording layer 70 to have sufficiently high light transmittance so that a signal having a high level can be obtained when data recorded in the first recording layer 50 or when data recorded in the second recording layer 60 are reproduced.

On the other hand, since a laser beam LB reflected by the second recording layer 60 and emitted through the light incidence plane 45a is detected when data recorded in the second recording layer 60 are to be reproduced and a laser beam LB reflected by the third recording layer 70 and emitted through the light incidence plane 45a is detected when data recorded in the third recording layer 70 are to be reproduced, each of the second recording layer 60 and the third recording layer 70 has a sufficiently high light reflection coefficient so that a signal having a high level can be obtained when data recorded in each of them are reproduced.

In this embodiment, each of the second recording layer 60 and the third recording layer 70 contains Zn, Si, S and O as a primary component and at least one metal selected from the group consisting of Mg, Al and Ti as an additive. In a study done by the inventors of the present invention, it was found that in the case where each of the second recording layer 60 and the third recording layer 70 contains Zn, Si, S and O as a primary component and at least one metal selected from the group consisting of Mg, Al and Ti as an additive, each of them has a high light transmittance for a laser beam LB having a wavelength of 400 nm to 430 nm.

Further, in this embodiment, the second recording layer 60 and the third recording layer 70 are formed so that the ratio D3/D2 of the thickness D3 of the third recording layer 70 to the thickness D2 of the second recording layer 60 is 0.40 to 0.70. A study carried out by the inventors of the present invention revealed that in the case where the second recording layer 60 and the third recording layer 70 are formed so that the thickness D2 of the second recording layer 60 is larger than the thickness D3 of the third recording layer 70, each of them has a much higher light transmittance for the laser beam LB having a wavelength of 400 nm to 430 nm.

Therefore, according to this embodiment, in the case where data are to be recorded in the first recording layer 50, since it is possible to suppress the reduction in the power of the laser beam LB to the minimum during the period required for arrival of the laser beam LB at the first recording layer 50, it is possible to record data in the first recording layer in a desired manner. On other hand, when data recorded in the first recording layer 50 are to be reproduced, since it is possible to suppress the reduction in the power of the laser beam LB to the minimum during the period required for arrival of the laser beam LB reflected by the first recording layer 50 at the light incidence plane 45a, it is possible to reproduce data recorded in the first recording layer 50 in a desired manner.

Further, in a study done by the inventors of the present invention, it was found that in the case where each of the second recording layer 60 and the third recording layer 70 contains Zn, Si, S and O as a primary component and at least one metal selected from the group consisting of Mg, Al and Ti as an additive and the thickness D2 of the second recording layer 60 is larger than the thickness D3 of the third recording layer 70, the reflection coefficient of the recording layer farther from the light incidence plane 45a with respect to the laser beam LB can be increased. Therefore, according to this embodiment, it is possible to reproduce data not only from the first recording layer 50 but also from the second recording layer 60 and the third recording layer 70 in a desired manner.

Further, it is preferable for the amount of the laser beam LB absorbed by the second recording layer 60 and that absorbed by the third recording layer 70 to be substantially equal to each other so that laser beam LBs L for recording data having substantially same powers are projected onto the second recording layer 60 and the third recording layer 70 and data can be similarly recorded therein.

Moreover, in order to similarly reproduce data recorded in the second recording layer 60 and the third recording layer 70, it is preferable for the reflection coefficient of the second recording layer 60 with respect to a laser beam LB focused onto the second recording layer 60 and projected thereonto via the third recording layer 70 and the reflection coefficient of the third recording layer 70 with respect to the laser beam LB focused and projected onto the third recording layer 70 to be substantially equal.

In a study done by the inventors of the present invention, it was found that in the case where the second recording layer 60 and the third recording layer 70 are formed so that the second recording layer 60 has a thickness of 15 nm to 50 nm and that the ratio D3/D2 of the thickness D3 of the third recording layer 70 to the thickness D2 of the second recording layer 60 is 0.40 to 0.70, the second recording layer 60 and the third recording layer 70 can be formed so that the amount of the laser beam LB absorbed by the second recording layer 60 and that absorbed by the third recording layer can be made substantially equal to each other and that the absorption coefficient of the second recording layer 60 with respect to the laser beam LB having a power and projected thereonto and that of the third recording layer with respect to the laser beam LB having a power and projected thereonto are sufficiently high, namely, 10% to 30%. Therefore, according to this embodiment, it is possible to record data in the second recording layer and the third recording layer in a desired manner.

In a further study done by the inventors of the present invention, it was found that in the case where each of the second recording layer 60 and the third recording layer 70 contains Zn, Si, S and O as a primary component and at least one metal selected from the group consisting of Mg, Al and Ti as an additive, the second recording layer 60 has a thickness of 15 nm to 50 nm and the ratio D3/D2 of the thickness D3 of the third recording layer 70 to the thickness D2 of the second recording layer 60 is 0.40 to 0.70, the second recording layer 60 and the third recording layer 70 can be formed so that the reflection coefficient of the second recording layer 60 and that of the third recording layer 70 are substantially equal to each other and that each of them has a sufficiently high reflection coefficient. Therefore, according to this embodiment, it is possible to reproduce data from the second recording layer 60 and the third recording layer 70 in a desired manner.

As shown in FIG. 4, the light transmission layer 45 is formed on the surface of the third recording layer 70.

The light transmission layer 45 serves to transmit the laser beam LB and the light incident plane 45a is constituted by one of the surfaces thereof.

As shown in FIG. 4, grooves G and lands L having a similar raised and depressed pattern to that of the grooves G and the lands L formed on the major surface of the second transparent intermediate layer 43 on the side of the third recording layer 70, namely, that of the grooves G and the lands L formed on the major surface of the support substrate 41 on the side of the first recording layer 50, is formed on the major surface of the light transmission layer 45 facing the third recording layer 70.

The light transmission layer 45 is formed by applying an ultraviolet ray curable resin solution onto the surface of the third recording layer 70 using a spin coating method to form a coating film and projecting ultraviolet rays onto the surface of the coating film, thereby curing the coating film. As a result, the raised and depressed pattern of the grooves G and the lands L formed on the major surface of the second transparent intermediate layer 43 on the side of the third recording layer 70, namely, the raised and depressed pattern of the grooves G and the lands L formed on the major surface of the support substrate 41 on the side of the first recording layer 50, is transferred onto the major surface of the light transmission layer 45 facing the third recording layer 70, thereby forming grooves G and lands L having a similar raised and depressed pattern to that formed on the one major surface of the support substrate 41 on the side of the first recording layer 50 on the major surface of the light transmission layer 45 facing the third recording layer 70.

It is necessary for the light transmission layer 45 to have sufficiently high light transmittance since the laser beam LB passes through the light transmission layer 45 when data are to be recorded in the first recording layer 50, the second recording layer 60 or the third recording layer 70 and when data recorded in the first recording layer 50, the second recording layer 60 or the third recording layer 70 are to be reproduced.

When data are to be recorded in the first recording layer 50 of the thus constituted optical recording disk 40, a laser beam LB having a wavelength of 400 nm to 430 nm is focused onto the first recording layer 50 via the light transmission layer 45.

As a result, the first recording layer 50 is heated and Si contained in the first recording film 53a as a primary component and Cu contained in the second recording film 53b as a primary component mix each other to form a mixed region. Since the reflection coefficient of the mixed region with respect to the laser beam LB is different from those of other blank regions, the mixed region can be used as a record mark.

In this embodiment, since each of the second recording layer 60 and the third recording layer 70 contains Zn, Si, S and O as a primary component and at least one metal selected from the group consisting of Mg, Al and Ti as an additive, the second recording layer 60 has a thickness of 15 nm to 50 nm and the ratio D3/D2 of the thickness D3 of the third recording layer 70 to the thickness D2 of the second recording layer 60 is 0.40 to 0.70, the second recording layer 60 and the third recording layer 70 have sufficiently high light transmittances with respect to the laser beam LB. Therefore, since it is possible to suppress the reduction in the power of the laser beam LB to the minimum when the laser beam LB passes through the third recording layer 70 and the second recording layer 60, data can be recorded in the first recording layer 50 in a desired manner.

On the other hand, in the case where data recorded in the first recording layer 50 are to be reproduced, since it is possible to suppress the reduction in the power of the laser beam LB to the minimum when the laser beam LB passes through the third recording layer 70 and the second recording layer 60 and it is possible to suppress the reduction in the power of the laser beam LB reflected by the first recording layer 50 to the minimum when the laser beam LB passes through the second recording layer 60 and the third recording layer 70, data recorded in the first recording layer 50 can be reproduced in a desired manner.

Further, in this embodiment, since the reflective film 51 is formed between the support substrate 41 and the first recording layer 50, the laser beam LB reflected by the reflective film 51 and the laser beam LB reflected by the first recording layer 50 interfere with each other, whereby the change in reflection coefficient between before and after the recording of data can be increased. Therefore, data recorded in the first recording layer 50 can be reproduced with high sensitivity.

On the other hand, when data are to be recorded in the second recording layer 60 of the optical recording disk 40, a laser beam LB having a wavelength of 400 nm to 430 nm is focused onto the second recording layer 60 via the light transmission layer 45.

As a result, the second recording layer is heated and Zn contained in the heated region of the second recording layer 60 in the form of a single substance reacts with S, whereby crystalline ZnS grains are formed. As a result, the crystalline ZnS grains nucleate and amorphous ZnS present around the crystalline ZnS grains crystallizes. Since the region where the crystalline ZnS grains have formed in this manner has a different reflection coefficient with respect to the laser beam LB having a wavelength of 400 nm to 430 nm from those other regions of the second recording layer 60, it can be used as a record mark and data are recorded in the second recording layer 60.

Further, when data are to be recorded in the third recording layer 70 of the optical recording disk 40, a laser beam LB having a wavelength of 400 nm to 430 nm is focused onto the third recording layer 70 via the light transmission layer 45.

In this embodiment, since the third recording layer 70 has the same composition as that of the second recording layer 60, when the laser beam LB is projected onto the third recording layer 70, a region of the third recording layer 70 irradiated with the laser beam LB is crystallized and data are recorded in the third recording layer 70 similarly to the second recording layer 60.

In this embodiment, since each of the second recording layer 60 and the third recording layer 70 contains Zn, Si, S and O as a primary component and at least one metal selected from the group consisting of Mg, Al and Ti as an additive, the second recording layer 60 has a thickness of 15 nm to 50 nm and the ratio D3/D2 of the thickness D3 of the third recording layer 70 to the thickness D2 of the second recording layer 60 is 0.40 to 0.70, the second recording layer 60 and the third recording layer 70 can be formed so that an amount of the laser beam LB absorbed by the second recording layer 60 and that absorbed by the third recording layer 70 can be made substantially equal to each other and that the absorption coefficient of the second recording layer 60 with respect to the laser beam LB having a power and projected thereonto and that of the third recording layer with respect to the laser beam LB having a power and projected thereonto are sufficiently high, namely, 10% to 30%. Therefore, according to this embodiment, it is possible to record data in the second recording layer 60 and the third recording layer 70 in a desired manner.

In a study done by the inventors of the present invention, it was found that in the optical recording disk 40 in which the grooves G and the lands L are formed on the one major surface of the support substrate 41, the major surface of the first transparent intermediate layer 42 facing the light transmission layer 45, the major surface of the second transparent intermediate layer 43 facing the light transmission layer 45 and the major surface of the light transmission layer 45 facing the support substrate 41, it is possible to suppress jitter of a signal obtained by reading data within a predetermined range, thereby suppressing reading errors, and maintain the level of a push-pull signal equal to or higher than a predetermined value, thereby enabling tracking control in a desired manner.

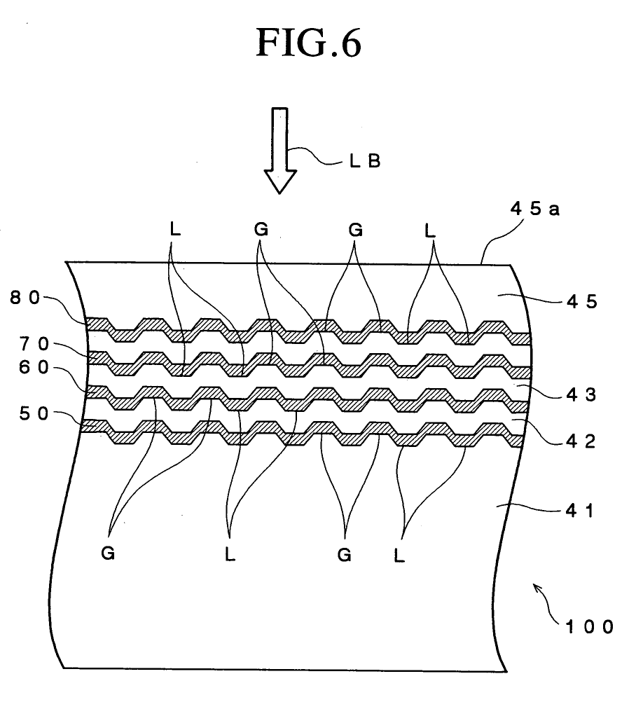

FIG. 6 is a schematic cross-sectional view showing an optical recording disk that is a further preferred embodiment of the present invention.

As shown in FIG. 6, the optical recording disk 100 according to this embodiment includes a support substrate 41, a first recording layer 50 formed on the surface of the support substrate 41, a first transparent intermediate layer 42 formed on the surface of the first recording layer 50, a second recording layer 60 formed on the surface of the first transparent intermediate layer 42, a second transparent intermediate layer 43 formed on the surface of the second recording layer 60, a third recording layer 70 formed on the surface of the second transparent intermediate layer 43, a third transparent intermediate layer 44 formed on the surface of the third recording layer 70, a fourth recording layer 80 formed on the surface of the third transparent intermediate layer 44 and a light transmission layer 45 formed on the surface of the fourth recording layer 80 and has a similar configuration to that of the optical recording disk 40 shown in FIGS. 4 and 5 except that the third transparent intermediate layer 44 and the fourth recording layer 80 are formed and that the it has four recording layers.

The third transparent intermediate layer 44 serves to space the third recording layer 70 and the fourth recording layer 80 apart by a physically and optically sufficient distance.

Similarly to in the optical recording disk 40 shown in FIGS. 4 and 5, in the optical recording disk 100 according to this embodiment, each of the one major surface of the support substrate 41, the major surface of the first transparent intermediate layer 42 facing the light transmission layer 45, the major surface of the second transparent intermediate layer 43 facing the light transmission layer 45 and the major surface of the third transparent intermediate layer 44 facing the light transmission layer 45 is formed with grooves G and lands L so that the depth Gd of the groove is equal to or larger than 15 nm and equal to or smaller than 25 nm, the half width Gw of the groove G is equal to or larger than 150 nm and equal to smaller than 230 nm and an angle θ that inclined surface between each groove G and neighboring land L makes with the one major surface of the support substrate 31 is equal to or larger than 12 degrees and equal to or smaller than 30 degrees.

Further, as shown in FIG. 6, a similar raised and depressed pattern of grooves G and lands L to that of the grooves G and the lands L formed on the one major surface of the support substrate 41 is formed on the major surface of the third transparent intermediate layer 44 facing the light transmission layer 45.

The third transparent intermediate layer 44 is formed by applying an ultraviolet ray curable resin solution onto the surface of the third recording layer 30 using a spin coating method to form a coating film and projecting ultraviolet rays onto the surface of the coating film via a stamper (not shown) whose surface is formed with a similar raised and depressed pattern to that of a stamper (not shown) used for fabricating the support substrate 41. As a result, the similar raised and depressed pattern of grooves G and lands L to that of the grooves G and the lands L formed on the one major surface of the support substrate 41 is formed on the major surface of the third transparent intermediate layer 44 facing the light transmission layer 45.

Further, in this embodiment, the grooves G and the lands L are formed in such a manner that each is wobbled so that the amplitude Wob thereof with respect to an imaginary center line thereof is equal to or larger than ±7 nm and equal to or smaller than ±25 nm.

It is preferable to form the fourth transparent intermediate layer 14 so as to have a thickness of 5 μm to 50 μm and it is more preferable to form it so as to have a thickness of 10 μm to 40 μm.

The fourth recording layer 80 is formed on the surface of the third transparent intermediate layer 44 by a vapor growth process such as a sputtering process using a target consisting of the mixture of ZnS and SiO₂ and a target consisting of at least one metal selected from the group consisting of Mg, Al and Ti.

In this embodiment, the same targets as those used for forming the second recording layer 60 and the third recording layer 70 are used and therefore, the fourth recording layer 80 has the same composition as that of each of the second recording layer 60 and the third recording layer 70.

The second recording layer 60, the third recording layer 70 and the fourth recording layer 80 are formed so that the second recording layer 60 has a thickness of 20 nm to 50 nm, that the ratio D3/D2 of the thickness D3 of the third recording layer 70 to the thickness D2 of the second recording layer 60 is 0.48 to 0.93, that the ratio D4/D2 of the thickness D4 of the fourth recording layer 80 to the thickness D2 of the second recording layer 60 is 0.39 to 0.70, and the thickness D2 of the second recording layer 60, the thickness D3 of the third recording layer 70 and the thickness D4 of the fourth recording layer 80 satisfy D2>D3>D4.

The inventors of the present invention conducted a study regarding the case where each of the second recording layer 60, the third recording layer 70 and the fourth recording layer 80 contains Zn, Si, S and 0 as a primary component and at least one metal selected from the group consisting of Mg, Al and Ti as an additive, the thickness D2 of the second recording layer 60, the thickness D3 of the third recording layer 70 and the thickness D4 of the fourth recording layer 80 satisfy D2>D3>D4. As a result, they found that in such a case each of the second recording layer 60, the third recording layer 70 and the fourth recording layer 80 has a sufficiently high light transmittance with respect to the laser beam LB. Therefore, according to this embodiment, since it is possible to suppress the reduction in the power of the laser beam LB to the minimum when the laser beam LB passes through the fourth recording layer 80, the third recording layer 70 and the second recording layer 60, data can be recorded in the first recording layer 50 in a desired manner. On the other hand, in the case where data recorded in the first recording layer 50 are to be reproduced, since it is possible to suppress the reduction in the power of the laser beam LB to the minimum when the laser beam LB passes through the third recording layer 70, the second recording layer 60 and the fourth recording layer 80 and it is possible to suppress the reduction in the power of the laser beam LB reflected by the first recording layer 50 to the minimum when the laser beam LB passes through the second recording layer 60, the third recording layer 70 and the fourth recording layer 80, data recorded in the first recording layer 50 can be reproduced in a desired manner.

Furthermore, the inventors of the present invention carried out a study regarding the case where each of the second recording layer 60, the third recording layer 70 and the fourth recording layer 80 contains Zn, Si, S and O as a primary component and at least one metal selected from the group consisting of Mg, Al and Ti as an additive and the thickness D2 of the second recording layer 60, the thickness D3 of the third recording layer 70 and the thickness D4 of the fourth recording layer 80 satisfy D2>D3>D4. As a result, they found that in such a case the reflection coefficient of the recording layer farther from the light incidence plane 45a with respect to the laser beam LB can be increased. Therefore, according to this embodiment, it is possible to reproduce data not only from the first recording layer 50 but also from the second recording layer 60, the third recording layer 70 and the fourth recording layer 80 in a desired manner.

Moreover, the inventors of the present invention conducted a study regarding the case where each of the second recording layer 60, the third recording layer 70 and the fourth recording layer 80 is contains Zn, Si, S and O as a primary component and at least one metal selected from the group consisting of Mg, Al and Ti as an additive, the second recording layer 60 has a thickness of 20 nm to 50 nm, the ratio D3/D2 of the thickness D3 of the third recording layer 70 to the thickness D2 of the second recording layer 60 is 0.48 to 0.93, and the ratio D4/D2 of the thickness D4 of the fourth recording layer 80 to the thickness D2 of the second recording layer 60 is 0.39 to 0.70 As a result they found that in such a case the second recording layer 60, the third recording layer 70 and the fourth recording layer 80 can be formed so that the amount of the laser beam LB absorbed by the second recording layer 60, that absorbed by the third recording layer 70 and that absorbed by the fourth recording layer 80 can be made substantially equal to each other and that each of the absorption coefficients of the second recording layer 60, the third recording layer 70 and the fourth recording layer 80 with respect to the laser beam LB having a power and projected thereonto via the light transmission layer 45 are sufficiently high, namely, 10% to 20%. Therefore, according to this embodiment, it is possible to record data in the second recording layer, the third recording layer and the fourth recording layer 80 in a desired manner.

Further, the inventors of the present invention conducted a study regarding the case where each of the second recording layer 60, the third recording layer 70 and the fourth recording layer 80 contains Zn, Si, S and O as a primary component and at least one metal selected from the group consisting of Mg, Al and Ti as an additive, the second recording layer 60 has a thickness of 20 nm to 50 nm, the ratio D3/D2 of the thickness D3 of the third recording layer 70 to the thickness D2 of the second recording layer 60 is 0.48 to 0.93, and the ratio D4/D2 of the thickness D4 of the fourth recording layer 80 to the thickness D2 of the second recording layer 60 is 0.39 to 0.70. As a result they found that in such a case the second recording layer 60, the third recording layer 70 and the fourth recording layer 80 can be formed so that the reflection coefficients of the second recording layer 60, the third recording layer 70 and the fourth recording layer 80 are substantially equal to each other and that each of them has a sufficiently high reflection coefficient. Therefore, according to this embodiment, it is possible to reproduce data from the second recording layer 60, the third recording layer 70 and the fourth recording layer 80 in a desired manner.

In a study done by the inventors of the present invention, it was found that in the optical recording disk 100 in which the grooves G and the lands L are formed on the one major surface of the support substrate 41, the major surface of the first transparent intermediate layer 42 facing the light transmission layer 45, the major surface of the second transparent intermediate layer 43 facing the light transmission layer 45 and the major surface of the third transparent intermediate layer 44 facing the light transmission layer 45, it is possible to suppress jitter of a signal obtained by reading data within a predetermined range, thereby suppressing reading errors, and maintain the level of a push-pull signal equal to or higher than a predetermined value, thereby enabling tracking control in a desired manner.

### WORKING EXAMPLES AND COMPARATIVE EXAMPLES

Hereinafter, working examples will be set out in order to further clarify the advantages of the present invention.

### Working Example 1

Each of stampers #1 to #19 in which grooves having different depths were formed were fabricated in the following manner.

First, a coupling agent layer was formed on a glass plate whose surface was polished and a photo-resist layer having a thickness of 12 nm was formed on the coupling agent layer by applying photo-resist onto the coupling agent layer using a spin coating method and baking the photo-resist at 85° C. for twenty minutes, thereby removing residual solvent.

The photo-resist layer was then exposed to a far ultraviolet laser beam LB having a wavelength of 266 nm with a track pitch of 320 nm using a cutting machine manufactured and sold by Sony Corporation.

Then, the photo-resist layer was developed to fabricate a photo-resist coated glass board.

Further, a thin layer of nickel was formed on the photo-resist layer of the photo-resist coated glass board using an electroless plating process.

A nickel electroformed film was then formed by conducting electroforming on the thin layer of nickel and the nickel electroformed film was removed from the photo-resist coated glass board, thereby fabricating a master board.

The master board was dipped into a KMnO₄ solution and oxidized, thereby forming an electroformed film and a mother board having a reverse raised and depressed pattern to that of the master board was fabricated by peeling the electroformed film off the surface of the master board.

The thus fabricated mother board was punched and the reverse surface thereof was polished, thereby fabricating a stamper #1.

Each of stampers #2 to #19 in which grooves having different depths Gd were formed was fabricated in the same manner of fabricating the stamper #1 except that the thickness of a photo-resist layer was varied.

Further, optical recording disk samples #1 to #19 having the same configuration as that shown in FIG. 1 were fabricated in the following manner using different ones of the thus fabricated stampers in which grooves having different depths were formed.

Polycarbonate substrates having a diameter of 120 mm and a thickness of 1.1 mm were fabricated by an injection molding process using the stampers #1 to #19 so that the grooves and the lands formed on the stampers #1 to #19 were transferred each onto the surface of a different one of the polycarbonate substrates, thereby forming grooves and lands on the polycarbonate substrates.

Further, a reflective layer consisting of Al, Pd and Cu whose atomic ratio was 98:1:1 and having a thickness of 100 nm was formed on the surface of each polycarbohate substrate using a sputtering process.

A second dielectric layer having a thickness of 28 nm was formed on the surface of the reflective layer by a sputtering process using a target consisting of a mixture of 80 mol % of ZnS and 20 mol % of SiO₂.

A second recording layer of CuAl having a thickness of 6 nm was then formed on the surface of the second dielectric layer using a sputtering process.

A first recording layer containing Si as a primary component and having a thickness of 6 nm was formed on the surface of the second recording layer using a sputtering process.

Further, a first dielectric layer having a thickness of 25 nm was formed on the first recording layer by a sputtering process using a target consisting of a mixture of 80% of ZnS and 20% of SiO₂.

A light transmission layer having a thickness of 100 μm was then formed by applying an ultraviolet ray curable resin solution onto the surface of the first dielectric layer using a spin coating method to form a coating layer and projecting ultraviolet rays onto the coating layer to cure the ultraviolet ray curable resin.

Thus, optical recording disk samples #1 to #19 formed with grooves having different depths Gd were fabricated.

Then, a laser beam having a wavelength of 405 nm was projected using an evaluation apparatus onto each of the optical recording disk samples #1 to #19 via an objective lens having a numerical aperture NA of 0.85 and push-pull signals of the optical recording disk samples #1 to #19 were measured and jitter of signals obtained by reproducing signals recorded on five continuous tracks of each of the optical recording disk samples #1 to #19 was measured.

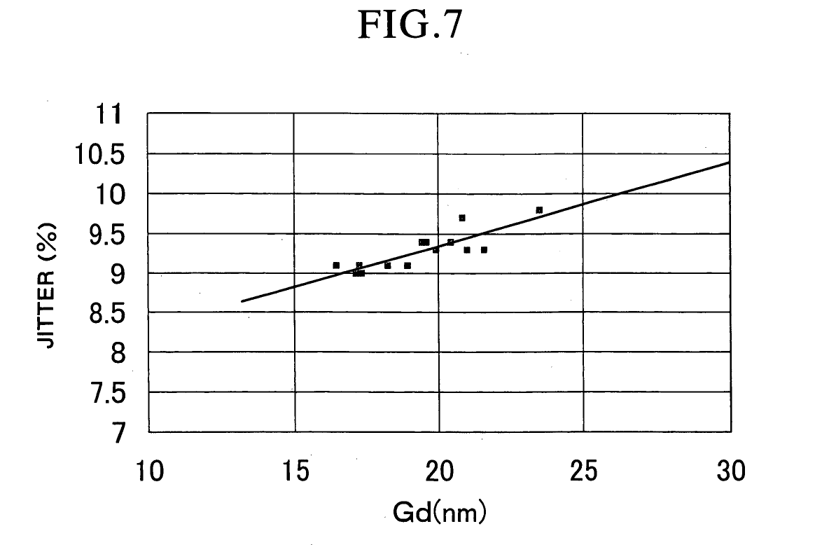

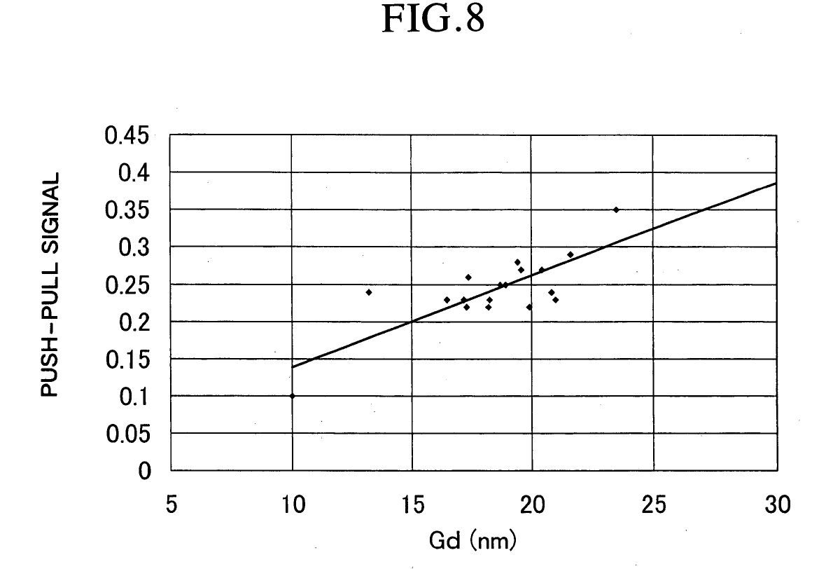

The results of measuring the relationship between the depth Gd of the grooves and the jitter are shown in FIG. 7 and the results of measuring the relationship between the depth Gd of the grooves and the push-pull signal are shown in FIG. 8.

As shown in FIG. 7, it was found that in the case where the depth Gd of the grooves was equal to or smaller than 25 nm, jitter of the reproduced signal could be suppressed to or lower than 10% and that it was possible to make the reproduced signals stable and suppress reading errors.

Further, as shown in FIG. 8, it was found that in the case where the depth Gd of the grooves was smaller than 15 nm, the level of the push-pull signal became too low and it was difficult to stably control tracking.

Therefore, it was found from Working Example 1 that it was necessary to form grooves each having a depth equal to or larger than 15 nm and equal to or smaller than 25 nm in order to suppress jitter to or lower than 10% and enable desired tracking control.

### Working Example 2

A stamper #20 formed with grooves having different half widths between zones was fabricated in the following manner.

First, a coupling agent layer was formed on a glass plate whose surface was polished and a photo-resist layer having a thickness of 22 nm was formed on the coupling agent layer by applying photo-resist onto the coupling agent layer using a spin coating method and baking the photo-resist at 85° C. for twenty minutes, thereby removing residual solvent.

The photo-resist layer was then exposed to a far ultraviolet laser beam having a wavelength of 266 nm with a track pitch of 320 nm using a cutting machine manufactured and sold by Sony Corporation. The photo-resist layer was exposed to a far ultraviolet laser beam whose power was set different in each zone.

Then, the photo-resist layer was developed to fabricate a photo-resist coated glass board formed with grooves having different half widths between zones.

A stamper #20 was fabricated using the thus fabricated photo-resist coated glass board in a similar manner to in Working Example 1.

Grooves each having a depth Gd of 20 nm were formed on the thus fabricated stamper #20.

Further, similarly to in Working Example 1, an optical recording disk sample #20 was fabricated using the stamper #20.

Then, a push-pull signal of the thus fabricated optical recording disk sample #20 was measured and jitter of a signal obtained by reproducing signals recorded on five continuous tracks of the optical recording disk sample #20 was measured.

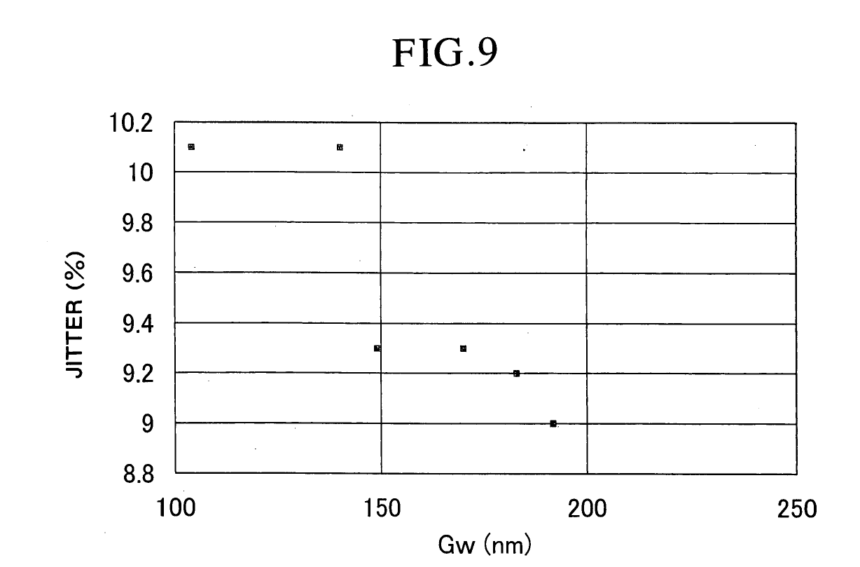

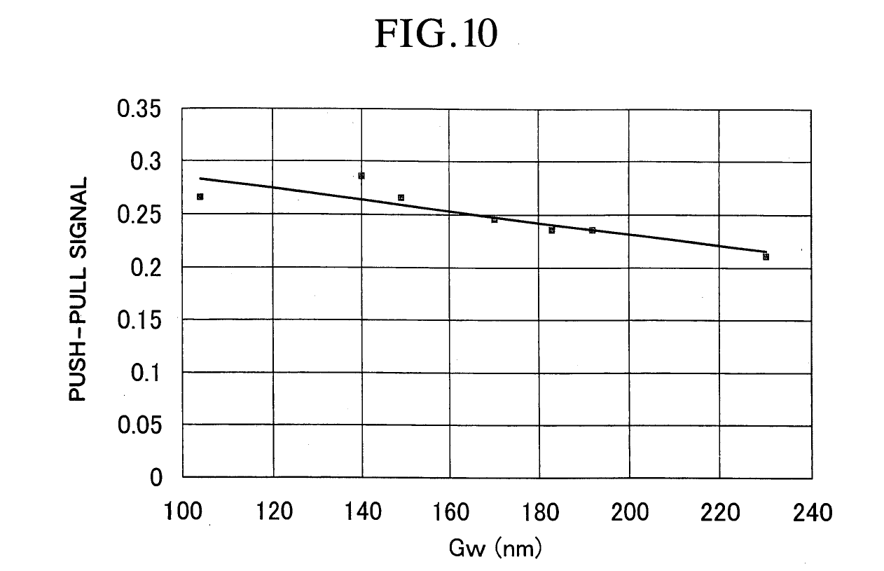

The results of the measurements are shown in FIGS. 9 and 10.

FIG. 9 is a graph showing how jitter of the reproduced signal varied with the half width Gw of the grooves of the optical recording samples and FIG. 10 is a graph showing how push-pull signals varied with the half width Gw of the grooves of the optical recording samples. In each of FIGS. 9 and 10, the abscissa of the graph represents the half width Gw of the grooves of the optical recording sample measured by a scanning electron microscope.

As shown in FIG. 9, it was found that jitter of the reproduced signal decreased as the half width Gw of the grooves became larger and that on the other hand, jitter of the reproduced signal became worse and exceeded 10% in the case where the half width Gw of the grooves was smaller that 150 nm.

Further, as shown in FIG. 10, it was found that the level of the push-pull signal became lower as the half width Gw of the grooves became larger and that in the case where the half width Gw of the grooves was larger than 230 nm, the level of the push-pull signal became too low to stably control tracking.

Therefore, it was found from Working Example 2 that in order to suppress jitter to or lower than 10% and enable desired tracking control it is necessary to form grooves so that the half width Gw thereof is equal to or larger than 150 nm and equal to or smaller than 230 nm.

### Working Example 3

A stamper #21 formed with grooves so that the amplitudes Wob of wobbling thereof with respect to an imaginary center line thereof were different between zones was fabricated in the following manner.

First, a coupling agent layer was formed on a glass plate whose surface was polished and a photo-resist layer having a thickness of 20 nm was formed on the coupling agent layer by applying photo-resist onto the coupling agent layer using a spin coating method and baking the photo-resist at 85° C. for twenty minutes, thereby removing residual solvent.

The photo-resist layer was then exposed to a far ultraviolet laser beam having a wavelength of 266 nm with a track pitch of 320 nm using a cutting machine manufactured and sold by Sony Corporation so that the half width of each groove was made 170 nm after the development.

At this time, the amplitude of wobbling of the grooves was varied by changing the voltage input to a wobble setting circuit of the cutting machine. The wobble frequency was set to be 1 MHz.

Then, the photo-resist layer was developed to fabricate a photo-resist coated glass board in which the amplitudes of wobbling of the grooves were different between zones.

A stamper #21 was fabricated using the thus fabricated photo-resist coated glass board in a similar manner to in Working Example 1.

Grooves each having the depth Gd of 18 nm were formed on the thus fabricated stamper #21.

Further, similarly to in Working Example 1, an optical recording disk sample #21 was fabricated using the stamper #21.

A ratio of a wobble signal to noise of the thus fabricated optical recording disk sample #21 was measured using the evaluation apparatus used in Working Example 1.

The evaluation conditions were as follows.

RBW (Resolution Band Width): 3 kHz

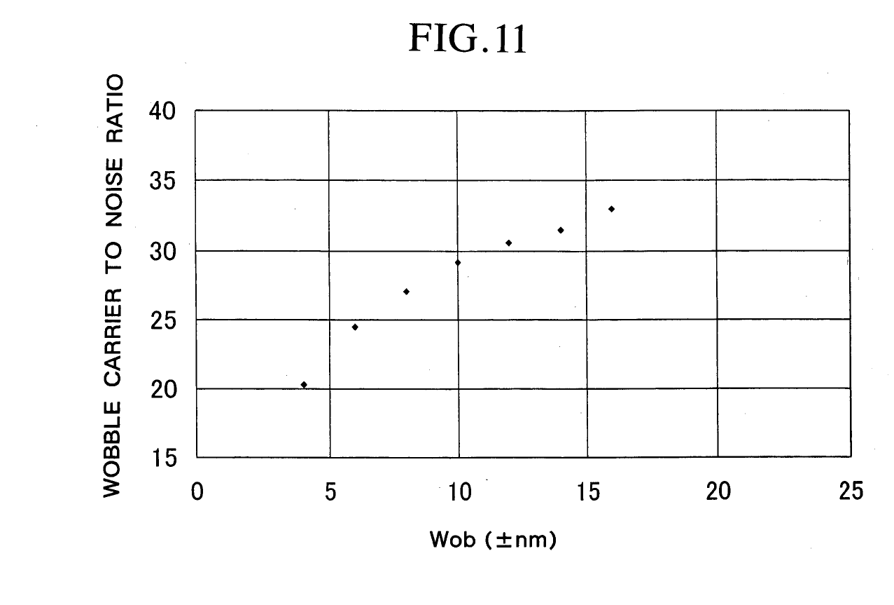

The results of evaluating the relationship between the amplitude Wob of wobbling of the grooves and the ratio of the wobble carrier to noise (wobble C/N ratio) are shown in FIG. 11.

As shown in FIG. 11, it was found that when the grooves and the lands were formed so that the amplitude Wob of wobbling of the grooves was equal to or larger than ±7 nm, a good ratio of the wobble carrier to noise (wobble C/N ratio) could be obtained.

On the other hand, a tracking error signals was input from the evaluation apparatus to an oscilloscope, thereby measuring a residual tracking error component of the optical recording disk sample #21 with respect to the amplitude Wob of wobbling of the grooves.

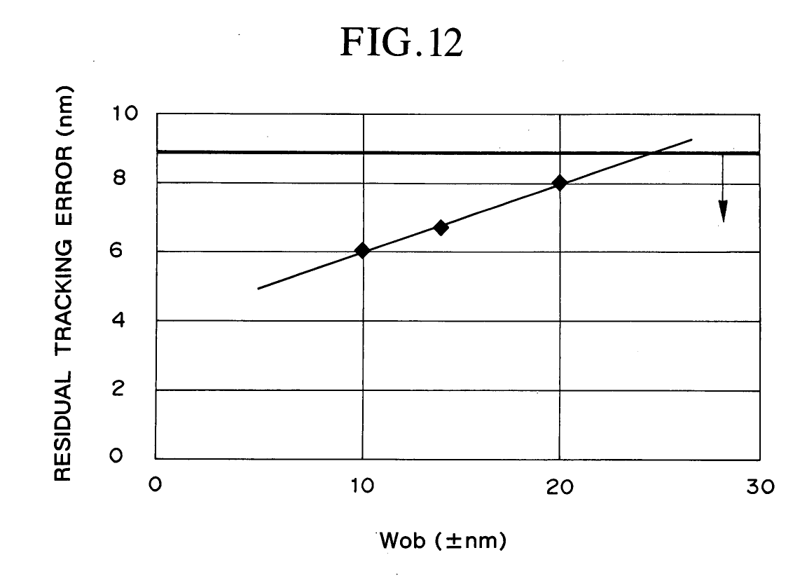

The results of the measurement are shown in FIG. 12.

As shown in FIG. 12, it was found that in the case where the amplitude Wob of wobbling of the grooves was larger than ±25 nm, the residual tracking error component became high.

Therefore, it was found from Working Example 3 that it is necessary in order to obtain a good ratio of the wobble carrier to noise (wobble C/N ratio) to form grooves and lands so that the amplitude Wob of wobbling of the grooves is equal to or larger than ±7 nm and that it is necessary in order to suppress a residual tracking error component to a low level to form grooves and lands so that the amplitude Wob of wobbling of the grooves was equal to or smaller than ±25 nm.

The present invention has thus been shown and described with reference to specific embodiments and working examples. However, it should be noted that the present invention is in no way limited to the details of the described arrangements but changes and modifications may be made without departing from the scope of the appended claims.

For example, in the above described embodiments, although the grooves G each having a substantially trapezoidal cross section and the lands L each having a substantially trapezoidal cross section are alternately formed on the one major surface of the support substrate 2, it is not absolutely necessary to form alternately the grooves G each having a substantially trapezoidal cross section and the lands L each having a substantially trapezoidal cross section on the one major surface of the support substrate 2.

Further, in the above described embodiments, although the grooves G and the lands L are formed so that the angle θ that inclined surface between each groove G and neighboring land L makes with the one major surface of the support substrate 2 is equal to or larger than 12 degrees and equal to or smaller than 30 degrees, it is not absolutely necessary to form the grooves G and the lands L so that the angle θ that the inclined surface between each groove G and neighboring land L makes with the one major surface of the support substrate 2 is equal to or larger than 12 degrees and equal to or smaller than 30 degrees.

Furthermore, in the above described embodiments, although the grooves G and the lands L are formed in such a manner that each is wobbled so that the amplitude Wob thereof with respect to an imaginary center line thereof is equal to or larger than ±7 nm and equal to or smaller than ±25 nm, it is not absolutely necessary to form the grooves G and the lands L in such a manner that each is wobbled so that the amplitude Wob thereof with respect to an imaginary center line thereof is equal to or larger than ±7 nm and equal to or smaller than ±25 nm.

Moreover, in the embodiment shown in FIGS. 1 and 2, the light transmission layer 9 is formed by applying an ultraviolet ray curable resin solution using a spin coating method onto the first dielectric layer 8 to form a coating layer and projecting ultraviolet rays onto the coating layer, thereby curing the ultraviolet ray curable resin, and the pattern of the grooves G and lands L formed on the one major surface of the support substrate 2 is transferred onto the major surface of the light transmission layer 9 facing the support substrate 2 so that a similar raised and depressed pattern to that of the grooves G and the lands L formed on the one major surface of the support substrate 2 is formed on the major surface of the light transmission layer 9 facing the support substrate 2, and in the embodiment shown in FIG. 3, the light transmission layer 13 is formed by applying an ultraviolet ray curable resin solution using a spin coating method onto the L1 layer 30 to form a coating layer and projecting ultraviolet rays onto the coating layer, thereby curing the ultraviolet ray curable resin, and the pattern of the grooves G and lands L formed on the one major surface of the support substrate 11 is transferred onto the major surface of the light transmission layer 13 facing the support substrate 11 so that a similar raised and depressed pattern to that of the grooves G and the lands L formed on the one major surface of the support substrate 11 is formed on the major surface of the light transmission layer 13 facing the support substrate 11. Further, in the embodiment shown in FIGS. 4 and 5, the light transmission layer 45 is formed by applying an ultraviolet ray curable resin solution using a spin coating method onto the third recording layer 70 to form a coating layer and projecting ultraviolet rays onto the coating layer, thereby curing the ultraviolet ray curable resin, and the pattern of the grooves G and lands L formed on the one major surface of the support substrate 41 is transferred onto the major surface of the light transmission layer 45 facing the support substrate 41 so that a similar raised and depressed pattern to that of the grooves G and the lands L formed on the one major surface of the support substrate 41 is formed on the major surface of the light transmission layer 45 facing the support substrate 41, and in the embodiment shown in FIG. 6, the light transmission layer 45 is formed by applying an ultraviolet ray curable resin solution using a spin coating method onto the fourth recording layer 80 to form a coating layer and projecting ultraviolet rays onto the coating layer, thereby curing the ultraviolet ray curable resin, and the pattern of the grooves G and lands L formed on the one major surface of the support substrate 41 is transferred onto the major surface of the light transmission layer 45 facing the support substrate 41 so that the same raised and depressed pattern of the grooves G and the lands L formed on the one major surface of the support substrate 41 is formed on the major surface of the light transmission layer 45 facing the support substrate 45. However, it is not absolutely necessary to form the light transmission layer 9, 13, 45 by applying an ultraviolet ray curable resin solution using a spin coating method onto the first dielectric layer 8, the L1 layer 30, the third recording layer 70 or the fourth recording layer 80 and the light transmission layer 9, 13, 45 may instead be formed by adhering a resin sheet having light transmittance capability on the surface of the first dielectric layer 8, the L1 layer 30, the third recording layer 70 or the fourth recording layer 80. In the case where the light transmission layer 9, 13, 45 is formed in this manner, the pattern of the grooves G and the lands L formed on the one major surface of the support substrate 2, 11, 41 is not transferred onto the major surface of the light transmission layer 9, 13, 45 facing the support substrate 2, 11, 41.

Furthermore, in the embodiment shown in FIGS. 1 and 2, although the first recording film 6 is disposed on the side of the light transmission layer 9 and the second recording film 5 is disposed on the side of the support substrate 2, it is possible to dispose the first recording film 6 on the side of the support substrate 2 and dispose the second recording film 5 on the side of the light transmission layer 9.

Moreover, in the embodiment shown in FIG. 3, although the first L1 recording film 33a containing Si as a primary component is disposed on the side of the light transmission layer 13 and the second L1 recording film 33b containing Cu as a primary component is disposed on the side of the support substrate 11, it is possible to dispose the first L1 recording film 33a containing Si as a primary component on the side of the support substrate 11 and dispose the second L1 recording film 33b containing Cu as a primary component on the side of the light transmission layer 13.

Further, in the embodiment shown in FIG. 3, although the first L0 recording film 23a containing Si as a primary component is disposed on the side of the light transmission layer 13 and the second L0 recording film 23b containing Cu as a primary component is disposed on the side of the support substrate 11, it is possible to dispose the first L0 recording film 23a containing Si as a primary component on the side of the support substrate 11 and dispose the second L0 recording film 23b containing Cu as a primary component on the side of the light transmission layer 13.

Furthermore, in the embodiment shown in FIG. 3, although the L0 layer 20 includes the first L0 recording film 23a containing Si as a primary component and the second L0 recording film 23b containing Cu as a primary component, it is not absolutely necessary for the L0 layer 20 to include the first L0 recording film 23a containing Si as a primary component and the second L0 recording film 23b containing Cu as a primary component and the L0 layer 20 may be constituted as a single recording film. Further, the L0 layer 20 may be constituted as a recording layer adapted to enable only data reading by forming prepits on the surface of the support substrate 11.

Moreover, in the embodiment shown in FIGS. 4 and 5 and the embodiment shown in FIG. 6, each of the second recording layer 60, the third recording layer 70 and the fourth recording layer 80 of the optical recording disk 40, 100 is formed by a vapor growth process such as the sputtering process using a target consisting of the mixture of ZnS and SiO₂ and a target consisting of at least one metal selected from the group consisting of Mg, Al and Ti. However, it is not absolutely necessary for each of the second recording layer 60, the third recording layer 70 and the fourth recording layer 80 of the optical recording disk 40, 100 to be formed by a vapor growth process such as the sputtering process using a target consisting of the mixture of ZnS and SiO₂ and a target consisting of at least one metal selected from the group consisting of Mg, Al and Ti, and each of the second recording layer 60, the third recording layer 70 and the fourth recording layer 80 of the optical recording disk 40, 100 may be formed by a vapor growth process such as the sputtering process using a target containing a mixture of ZnS and SiO₂ as a primary component and a target containing at least one metal selected from the group consisting of Mg, Al and Ti as a primary component.

Further, in the embodiment shown in FIGS. 4 and 5 and the embodiment shown in FIG. 6, each of the second recording layer 60, the third recording layer 70 and the fourth recording layer 80 of the optical recording disk 40, 100 is formed by a vapor growth process such as the sputtering process using a target consisting of the mixture of ZnS and SiO₂ and a target consisting of at least one metal selected from the group consisting of Mg, Al and Ti and as a result, each of the second recording layer 60, the third recording layer 70 and the fourth recording layer 80 of the optical recording disk 40, 100 contains Zn, Si, O and S as a primary component and at least one metal selected from the group consisting of Mg, Al and Ti as an additive. However, it is not absolutely necessary for each of the second recording layer 60, the third recording layer 70 and the fourth recording layer 80 of the optical recording disk 40, 100 to be formed by a vapor growth process such as the sputtering process using a target consisting of the mixture of ZnS and SiO₂ and a target consisting of at least one metal selected from the group consisting of Mg, Al and Ti and each of the second recording layer 60, the third recording layer 70 and the fourth recording layer 80 of the optical recording disk 40, 100 can be formed by a vapor growth process such as the sputtering process using a target consisting of a mixture of La₂O₃, SiO₂ and Si₃N₄ as a primary component and a target containing at least one metal selected from the group consisting of Mg, Al and Ti as a primary component. In the case where each of the second recording layer 60, the third recording layer 70 and the fourth recording layer 80 of the optical recording disk 40, 100 is formed in this manner, each of the second recording layer 60, the third recording layer 70 and the fourth recording layer 80 contains La, Si, O and S as a primary component and at least one metal selected from the group consisting of Mg, Al and Ti as an additive.

Furthermore, in the embodiment shown in FIGS. 4 and 5 and the embodiment shown in FIG. 6, although the second recording layer 60, the third recording layer 70 and the fourth recording layer 80 of the optical recording disk 40, 100 have the same composition, it is sufficient for differences in the contents of one metal selected from the group consisting of Zn, Si, O and S to be equal to or smaller than 5 atomic % and it is not absolutely necessary the second recording layer 60, the third recording layer 70 and the fourth recording layer 80 of the optical recording disk 40, 100 to have the same composition.

Further, although each of the second recording layer 60 and the third recording layer 70 of the optical recording disk 40 contains Zn, Si, O and S as a primary component and at least one metal selected from the group consisting of Mg, Al and Ti as an additive in the embodiment shown in FIGS. 4 and 5, it is not absolutely necessary for each of the second recording layer 60 and the third recording layer 70 of the optical recording disk 40 to contain Zn, Si, O and S as a primary component and at least one metal selected from the group consisting of Mg, Al and Ti as an additive. It is sufficient for at least one of the second recording layer 60 and the third recording layer 70 of the optical recording disk 40 to contain at least one metal M selected from the group consisting of Ni, Cu, Si, Ti, Ge, Zr, Nb, Mo, In, Sn, W, Pb, Bi, Zn and La and an element X which can combine with the metal M upon being irradiated with a laser beam LB for recording data, thereby forming a crystal of a compound of the element X with the metal M and at least one of the second recording layer 60 and the third recording layer 70 of the optical recording disk 40 may contain at least one metal selected from the group consisting of Ni, Cu, Si, Ti, Ge, Zr, Nb, Mo, In, Sn, W, Pb, Bi, Zn and La and at least one element selected from the group consisting of S, O, C and N as a primary component and at least one metal selected from the group consisting of Mg, Al and Ti as an additive.

Furthermore, although each of the second recording layer 60, the third recording layer 70 and the fourth recording layer 80 of the optical recording disk 100 contains Zn, Si, O and S as a primary component and at least one metal selected from the group consisting of Mg, Al and Ti as an additive in the embodiment shown in FIG. 6, it is not absolutely necessary for each of the second recording layer 60, the third recording layer 70 and the fourth recording layer 80 of the optical recording disk 100 to contain Zn, Si, O and S as a primary component and at least one metal selected from the group consisting of Mg, Al and Ti as an additive. It is sufficient for at least one of the second recording layer 60, the third recording layer 70 and the fourth recording layer 80 of the optical recording disk 100 to contain at least one metal M selected from the group consisting of Ni, Cu, Si, Ti, Ge, Zr, Nb, Mo, In, Sn, W, Pb, Bi, Zn and La and an element X which can combine with the metal M upon being irradiated with a laser beam LB for recording data, thereby forming a crystal of a compound of the, element X with the metal M and at least one of the second recording layer 60, the third recording layer 70 and the fourth recording layer 80 of the optical recording disk 100 may contain at least one metal selected from the group consisting of Ni, Cu, Si, Ti, Ge, Zr, Nb, Mo, In, Sn, W, Pb, Bi, Zn and La and at least one element selected from the group consisting of S, O, C and N as a primary component and at least one metal selected from the group consisting of Mg, Al and Ti as an additive.

Moreover, in the embodiment shown in FIGS. 4 and 5 and the embodiment shown in FIG. 6, although each of the second recording layer 60, the third recording layer 70 and the fourth recording layer 80 of the optical recording disk 40, 100 is formed using a target consisting of at least one metal selected from the group consisting of Mg, Al and Ti, each of the second recording layer 60, the third recording layer 70 and the fourth recording layer 80 of the optical recording disk 40, 100 may be formed using a target containing Zn or La as a primary component.

Furthermore, in the embodiment shown in FIGS. 4 and 5, the optical recording disk 40 includes the support substrate 41, the light transmission layer 45 and the first recording layer 50, the second recording layer 60 and the third recording layer 70 formed between the support substrate 41 and the light transmission layer 45, and in the embodiment shown in FIG. 6, the optical recording disk 100 includes the support substrate 41, the light transmission layer 45 and the first recording layer 50, the second recording layer 60, the third recording layer 70 and the fourth recording layer 80 formed between the support substrate 41 and the light transmission layer 45. However, the present invention is not limited to an optical recording disk including three recording layers or four recording layers but can be widely applied to an optical recording disk including two or more recording layers.

Further, in the embodiment shown in FIGS. 4 and 5 and the embodiment shown in FIG. 6, although the first recording layer 50 of the optical recording disk 40, 100 includes the first recording film 53a containing Cu as a primary component and the second recording film 53b containing Si as a primary component, it is not absolutely necessary for the first recording layer 50 of the optical recording disk 40, 100 to include the first recording film 53a containing Cu as a primary component and the second recording film 53b containing Si as a primary component. The first recording layer 50 of the optical recording disk 10, 100 may be formed so as to contain at least one metal selected from the group consisting of Ni, Cu, Si, Ti, Ge, Zr, Nb, Mo, In, Sn, W, Pb, Bi, Zn and La and at least one element selected from the group consisting of S, O, C and N as a primary component and at least one metal selected from the group consisting of Mg, Al and Ti as an additive and further, the first recording layer 50 of the optical recording disk 40, 100 may be formed so as to contain at least one metal M selected from the group consisting of Ni, Cu, Si, Ti, Ge, Zr, Nb, Mo, In, Sn, W, Pb, Bi, Zn and La and an element X which can combine with the metal M upon being irradiated with a laser beam LB for recording data, thereby forming a crystal of a compound of the element X with the metal M.

Furthermore, in the embodiment shown in FIGS. 4 and 5 and the embodiment shown in FIG. 6, although the first recording layer 50 of the optical recording disk 40, 100 includes the first recording film 53a containing Cu as a primary component and the second recording film 53b containing Si as a primary component, instead of the first recording layer 50, the support substrate 41 or the first transparent intermediate layer 42 can be utilized as a recording layer adapted to enable only data reading by forming pits on the surface of the support substrate 41 or the first transparent intermediate layer 42 and recording data therein.

According to the present invention, it is possible to provide an optical recording disk which can suppress jitter of a signal obtained by reading data within a predetermined range, thereby suppressing reading errors, and maintain the level of a push-pull signal equal to or higher than a predetermined value, thereby enabling tracking control in a desired manner.

1. An optical recording disk comprising a support substrate, grooves and lands alternately formed on one major surface of the support substrate, an optical functioning layer formed on the one major surface of the support substrate on which the grooves and the lands are formed and including at least one recording layer and a light transmission layer formed on the optical functioning layer, the grooves and the lands being formed so that the depth Gd of each of the grooves is equal to or larger than 15 nm and equal to or smaller than 25 nm and the half width Gw is equal to or larger than 150 nm and is equal to or smaller than 230 nm, and the at least one recording layer containing an inorganic element.

2. An optical recording disk in accordance with claim 1, wherein each of the grooves has a substantially trapezoidal cross section and each of the lands has a substantially trapezoidal cross section.

3. An optical recording disk in accordance with claim 2, wherein the grooves and the lands are formed so that an angle θ the inclined surface between each groove and neighboring land makes with the support substrate is equal to or larger than 12 degrees and equal to or smaller than 30 degrees.

4. An optical recording disk in accordance with claim 1, wherein the grooves and the lands are formed in such a manner that each is wobbled so that the amplitude thereof with respect to an imaginary center line thereof is equal to or larger than ±7 nm.

5. An optical recording disk in accordance with claim 32, wherein the grooves and the lands are formed in such a manner that each is wobbled so that the amplitude thereof with respect to an imaginary center line thereof is equal to or larger than ±7 nm.

6. An optical recording disk in accordance with claim 4, wherein the grooves and the lands are formed in such a manner that each is wobbled so that the amplitude thereof with respect to an imaginary center line thereof is equal to or smaller than ±25 nm.

7. An optical recording disk in accordance with claim 5, wherein the grooves and the lands are formed in such a manner that each is wobbled so that the amplitude thereof with respect to an imaginary center line thereof is equal to or smaller than ±25 nm.

8. An optical recording disk in accordance with claim 1, wherein the at least one recording layer is constituted by a first recording film containing one element selected from the group consisting of Si, Ge, Sn, Mg, C, Al, Zn, In, Cu, Ti and Bi as a primary component and a second recording film provided in the vicinity of the first recording film and containing one element selected from the group consisting of Cu, Al, Zn, Ag, Ti and Si and different from the element contained in the first recording film as a primary component.

9. An optical recording disk in accordance with claim 3, wherein the at least one recording layer is constituted by a first recording film containing one element selected from the group consisting of Si, Ge, Sn, Mg, C, Al, Zn, In, Cu, Ti and Bi as a primary component and a second recording film provided in the vicinity of the first recording film and containing one element selected from the group consisting of Cu, Al, Zn, Ag, Ti and Si and different from the element contained in the first recording film as a primary component.

10. An optical recording disk in accordance with claim 5, wherein the at least one recording layer is constituted by a first recording film containing one element selected from the group consisting of Si, Ge, Sn, Mg, C, Al, Zn, In, Cu, Ti and Bi as a primary component and a second recording film provided in the vicinity of the first recording film and containing one element selected from the group consisting of Cu, Al, Zn, Ag, Ti and Si and different from the element contained in the first recording film as a primary component.

11. An optical recording disk in accordance with claim 1, which comprises a plurality of recording layers laminated via at least intermediate layers, at least one of the recording layers other than a recording layer farthest from a light transmission layer among the plurality of recording layers containing at least one metal M selected from a group consisting of Ni, Cu, Si, Ti, Ge, Zr, Nb, Mo, In, Sn, W, Pb, Bi, Zn and La and an element X which can combine with the metal M upon being irradiated with a laser beam for recording data, thereby forming a crystal of a compound of the element X with the metal M.

12. An optical recording disk in accordance with claim 3, which comprises a plurality of recording layers laminated via at least intermediate layers, at least one of the recording layers other than a recording layer farthest from a light transmission layer among the plurality of recording layers containing at least one metal M selected from a group consisting of Ni, Cu, Si, Ti, Ge, Zr, Nb, Mo, In, Sn, W, Pb, Bi, Zn and La and an element X which can combine with the metal M upon being irradiated with a laser beam for recording data, thereby forming a crystal of a compound of the element X with the metal M.

13. An optical recording disk in accordance with claim 5, which comprises a plurality of recording layers laminated via at least intermediate layers, at least one of the recording layers other than a recording layer farthest from a light transmission layer among the plurality of recording layers containing at least one metal M selected from a group consisting of Ni, Cu, Si, Ti, Ge, Zr, Nb, Mo, In, Sn, W, Pb, Bi, Zn and La and an element X which can combine with the metal M upon being irradiated with a laser beam for recording data, thereby forming a crystal of a compound of the element X with the metal M.

14. An optical recording disk in accordance with claim 1, which comprises a plurality of recording layers laminated via at least intermediate layers, at least one of the recording layers other than a recording layer farthest from a light transmission layer among the plurality of recording layers containing at least one kind of metal selected from a group consisting of Ni, Cu, Si, Ti, Ge, Zr, Nb, Mo, In, Sn, W, Pb, Bi, Zn and La and at least one element selected from a group consisting of S,O, C and N as a primary component and being added with at least one kind of metal selected from a group consisting of Mg, Al and Ti.

15. An optical recording disk in accordance with claim 3, which comprises a plurality of recording layers laminated via at least intermediate layers, at least one of the recording layers other than a recording layer farthest from a light transmission layer among the plurality of recording layers containing at least one kind of metal selected from a group consisting of Ni, Cu, Si, Ti, Ge, Zr, Nb, Mo, In, Sn, W, Pb, Bi, Zn and La and at least one element selected from a group consisting of S,O, C and N as a primary component and being added with at least one kind of metal selected from a group consisting of Mg, Al and Ti.

16. An optical recording disk in accordance with claim 5, which comprises a plurality of recording layers laminated via at least intermediate layers, at least one of the recording layers other than a recording layer farthest from a light transmission layer among the plurality of recording layers containing at least one kind of metal selected from a group consisting of Ni, Cu, Si, Ti, Ge, Zr, Nb, Mo, In, Sn, W, Pb, Bi, Zn and La and at least one element selected from a group consisting of S,O, C and N as a primary component and being added with at least one kind of metal selected from a group consisting of Mg, Al and Ti.

17. An optical recording disk in accordance with claim 1, wherein the at least one of the recording layers other than the recording layer farthest from a light transmission layer is formed by a vapor growth process using a target containing at least one metal selected from a group consisting of Ni, Cu, Si, Ti, Ge, Zr, Nb, Mo, In, Sn, W, Pb, Bi, Zn and La and at least one element selected from a group consisting of S,O, C and N as a primary component and a target containing at least one metal selected from a group consisting of Mg, Al and Ti as a primary component.

18. An optical recording disk in accordance with claim 3, wherein the at least one of the recording layers other than the recording layer farthest from a light transmission layer is formed by a vapor growth process using a target containing at least one metal selected from a group consisting of Ni, Cu, Si, Ti, Ge, Zr, Nb, Mo, In, Sn, W, Pb, Bi, Zn and La and at least one element selected from a group consisting of S,O, C and N as a primary component and a target containing at least one metal selected from a group consisting of Mg, Al and Ti as a primary component.

19. An optical recording disk in accordance with claim 5, wherein the at least one of the recording layers other than the recording layer farthest from a light transmission layer is formed by a vapor growth process using a target containing at least one metal selected from a group consisting of Ni, Cu, Si, Ti, Ge, Zr, Nb, Mo, In, Sn, W, Pb, Bi, Zn and La and at least one element selected from a group consisting of S,O, C and N as a primary component and a target containing at least one metal selected from a group consisting of Mg, Al and Ti as a primary component.
